(19) United States
(12) Patent Application Publication
(10) Pub. No.: US 2013/0057371 A1
(43) Pub. Date: Mar. 7, 2013

(54) COATED METAL POWDER, POWDER MAGNETIC CORE AND METHOD FOR PRODUCING SAME

(71) Applicants: Takehiro Shimoyama, Tsukuba-shi (JP); Tetsushi Maruyama, Tsukuba-shi (JP)

(72) Inventors: Takehiro Shimoyama, Tsukuba-shi (JP); Tetsushi Maruyama, Tsukuba-shi (JP)

(21) Appl. No.: 13/640,172

(22) PCT Filed: Apr. 8, 2011
(86) PCT No.: PCT/JP2011/058937

§ 371 Date: Nov. 19, 2012

(30) Foreign Application Priority Data
Apr. 9, 2010 (JP) 2010-090679
Nov. 8, 2010 (JP) 2010-250236

(51) Int. Cl. H01F 1/33; H01F 3/08; B22F 3/12; H01F 41/02; B05D 7/14; B05D 1/36

(52) U.S. Cl. 335/297; 428/405; 427/214; 419/10

(57) ABSTRACT

A coated metal powder is a metal powder that contains iron as a main component, and an insulating layer that is formed on a surface of the metal powder and is formed from calcium phosphate and a metal oxide, in which an organosilicon compound is contained on a surface of the insulating layer or inside the insulating layer.

### TECHNICAL FIELD

The present invention relates to a coated metal powder, a powder magnetic core, and a method for producing the same.

### BACKGROUND ART

There are many products, which use electromagnetism, such as a voltage inverter (transformer), an electric motor (motor), a generator, a speaker, an induction heater, and various actuators. Many of these products use an alternating magnetic field and commonly, the alternating magnetic field is generated by a coil provided with a magnetic core that is arranged at the center of the coil. Therefore, performance of the electromagnetic device depends on performance of the coil and the performance of the coil depends on performance of the magnetic core. As a result, it is very important to improve the performance of the magnetic core so as to improve the performance of the electromagnetic device or to realize miniaturization of the electromagnetic device.

In the magnetic core, a ferrite magnetic core has a disadvantage in that a saturation magnetic flux density is small. Conversely, a powder magnetic core that is manufactured by molding metal powders has a higher saturation magnetic flux density than that of soft magnetic ferrite. In addition, magnetic characteristics capable of obtaining a large magnetic flux density with a small applied magnetic field, and magnetic characteristics in which energy loss is small with variation in the magnetic flux density are requested in the powder magnetic core from requests for improvement in energy exchange efficiency or low heat generation.

In the case of using the powder magnetic core in an alternating magnetic field, energy loss called core loss occurs. This core loss is expressed as hysteresis loss, eddy current loss, and the sum of eddy currents, and the hysteresis loss and the eddy current loss are mainly problematic. The hysteresis loss is proportional to an operation frequency, and the eddy current loss is proportional to a square of the operation frequency. Therefore, the hysteresis loss is dominant at a low frequency domain, and the eddy current loss is dominant at a high frequency domain. It is necessary for the powder magnetic core to have magnetic characteristics of reducing occurrence of the core loss.

To reduce the hysteresis loss of the powder magnetic core, it is preferable to make migration of a magnetic domain wall easy. Therefore, it is preferable to lower a coercive force of soft magnetic powders. When this coercive force is lowered, improvement in an initial permeability and reduction in the hysteresis loss are realized.

On the other hand, the powder magnetic core that is molded in a high density has a high magnetic flux density. However, in the powder magnetic core that is molded in a high density, strain occurs greatly in particles of the soft magnetic powders at the time of being molded. This strain is a main cause of increasing the hysteresis loss.

To remove this strain, a high-temperature heat treatment process called annealing is effective. For soft magnetic powders containing iron as a main component, a high annealing temperature of 600° C. or more is necessary so as to remove the strain. However, at the high annealing temperature of 600° C. or more, in a case where an insulation process of phosphate series, an insulting film is broken and lost, and thus the eddy current loss increases (Patent Literature 1 described below).

Therefore, insulation coating, which is excellent in heat resistance, has been reviewed. For example, Patent Literature 2 described below suggests a method of reducing the eddy current loss by coating a surface of metal powders with an inorganic material such as titania, silica, and alumina. In addition, in Patent literature 3 described below, raising heat resistance is attempted by performing insulation treatment of phosphate series with respect to iron powders and applying a film of a silicone resin thereon. In addition, Patent Literature 4 described below suggests an insulating film using oxides of alkaline earth metals or rare-earth elements, but a specific resistivity after annealing at 500° C. is only approximately 10 μΩm.

On the other hand, Patent Literature 5 reports powders for a powder magnetic core. In regard to the powders, Fe—Si alloy powders are used as metal powders, and the Fe—Si alloy powders include an insulating film made of silica, a silane coupling agent, and a silicone resin. These magnetic powders include an insulating film, which has excellent heat resistance and a specific resistivity, thereon. Therefore, in the powder magnetic core that is obtained from these powders, the core loss may be significantly reduced. The reason is not completely clear, but it is assumed as follows. Specifically, in the case of using Fe—Si powders, due to high affinity between a silanol group (Si—OH) of a silicone resin and a SiO₂ film that is present on a surface of the Fe—Si powders and is formed through natural oxidization, an insulating film made of a silicone resin is uniformly formed, and the silicone resin and Si in the Fe—Si powders react with each other during heat treatment and thus a strong SiO₂-based film is formed. As a result, an insulting film having high heat resistance and a high specific resistivity is formed. On the other hand, coated metal powders that are formed using pure iron powders cannot obtain the same operation effect as the case of using the Fe—Si powders.

### CITATION LIST

### Patent Literature

[Patent Literature 1] Japanese Unexamined Patent Application Publication No. 2000-504785
[Patent Literature 2] Japanese Unexamined Patent Application Publication No. 2003-332116
[Patent Literature 3] Japanese Unexamined Patent Application Publication No. 2006-5173
[Patent Literature 4] Japanese Unexamined Patent Application Publication No. 2005-93350
[Patent Literature 5] Japanese Unexamined Patent Application Publication No. 2009-259939

### SUMMARY OF INVENTION

### Technical Problem

However, in the case of using Fe—Si powders, a high-pressure and high-temperature process and an expensive material are necessary at the time of molding the powder magnetic core. This is because the Fe—Si powders have a hard property compared to other magnetic powders, for example, pure iron powders, and thus a very high molding pressure is necessary during molding, or it is necessary to perform warm molding at a high temperature to mold a resin while annealing the resin. In addition, this heat resistance resin is expensive, but it is not likely to obtain mechanical properties of a molded body, which correspond to the high cost. On the other hand, in cheap pure iron powders, unevenness is present on a surface thereof at a lot of places and thus uniform film formation is difficult, in addition to the bonding property of the film as described above. Therefore, an effective method of forming an insulating film is not established yet.

Therefore, an object of the present invention is to provide a powder magnetic core that may be produced, even when using a powder in which unevenness is formed and which has a distorted shape, and that is excellent in magnetic characteristics or mechanical properties, a coated metal powder that is used for producing the powder magnetic core, and a method of producing the same.

### Solution to Problem

According to an aspect of the invention, there is provided a coated metal powder comprising a metal powder containing iron as a main component, and an insulating layer consisting of calcium phosphate and a metal oxide formed on a surface of the metal powder, wherein an organosilicon compound is located on a surface of or inside of the insulating layer.

The coated metal powder according to the present invention has the above-described configuration, and thus an excellent insulation property is exhibited due to a synergistic effect of the insulating layer that is formed from an inorganic material and the organosilicon compound, and coated metal powders are strongly bonded to each other. Therefore, when the coated metal powders are used for a powder magnetic core, magnetic characteristics may be significantly improved. Furthermore, it is considered that the organosilicon compound serves as a lubricant at the time of manufacturing a molded body, and thus the organosilicon compound prevents the insulating layer from being broken due to excessive stress. From this viewpoint, a relatively excellent insulation property may be obtained for the powder magnetic core formed from the coated metal powder.

In addition, the iron powder has a soft property compared to Fe—Si powder, that is, a low-pressure molding property. Therefore, when the metal powder containing iron as a main component is used as a magnetic powder, a molding pressure is suitable in that molding pressure is made as much as possible into low pressure, and the life of a mold can be taken into consideration. Therefore, a powder magnetic core having a high molding density and a high magnetic flux density may be produced. In addition, the metal powder containing an iron powder as a main component is not expensive compared to the Fe—Si alloy powder, and thus there is an advantage that the metal powder is industrially preferable.

As the organosilicon compound, an alkoxysilane or a reaction product thereof is applicable, and it is preferable that the reaction product be a hydrolysate of the alkoxysilane and/or a hydrolysis condensate of the alkoxysilane. In this case, when an alkoxy group of the alkoxysilane, and an OH⁻ group in a structure of hydroxyapatite or an OH⁻ group on a surface of a metal oxide, which is described later, are hydrolyzed, it is considered that the alkoxysilane, and hydroxyapatite and the metal oxide may be strongly bonded to each other. The powder magnetic core formed from this coated metal powder exhibits a relatively excellent insulation property and mechanical characteristics.

It is preferable that the alkoxysilane has a phenyl group or a benzyl group. Particularly, it is more preferable that as the alkoxysilane, methyltriethoxysilane, tetraethoxysilane, or the like be used, and still more preferably phenyltriethoxysilane, diphenyldiethoxysilane, or the like. The powder magnetic core formed from this coated metal powder exhibits a relatively excellent insulation property.

As the organosilicon compound, a silicone resin may be applicable. In addition, it is preferable that the silicone resin contain at least one compound of (1), (2), and (3) described below. (1) A polyorganosiloxane containing a bifunctional siloxane unit. (2) A mixture of a polyorganosiloxane containing at least one of a monofunctional siloxane unit, a trifunctional siloxane unit, and a tetrafunctional siloxane unit, and a polyorganosiloxane including a bifunctional siloxane unit. (3) A polyorganosiloxane containing at least one of a monofunctional siloxane unit, a trifunctional siloxane unit, and a tetrafunctional siloxane unit, and a bifunctional siloxane unit.

In the above-described silicone resin, accompanying temperature increase, a siloxane bonding progresses. Therefore, entire crosslinking is obtained from partial crosslinking by performing a high-temperature treatment such as annealing, and thus when the powder magnetic core is formed, film strength is improved. In addition, since the film formed from the silicone resin is excellent in heat resistance, even when high-temperature heating such as annealing is performed with the powder magnetic core after being molded, the powder magnetic core is not broken and the above-described crosslinking further progresses, and thus bonding between particles of a magnetic core powder is enhanced.

In addition, it is preferable that the compound of (1), (2), or (3) have an alkyl group and/or a phenyl group as an organo group. Particularly, in a case where the compound of (1), (2), or (3) has the phenyl group, when the coated metal powder is molded into a powder magnetic core, the heat resistance may be further improved.

It is preferable that the silicone resin be a curable silicone resin. A film formed from this silicone resin functions as an insulating film that covers a surface of an inorganic insulating material, but also as a binder that bonds constituent particles.

It is preferable that the calcium phosphate contain at least one selected from the group consisting of monobasic calcium phosphate, dibasic calcium phosphate, dibasic calcium phosphate (anhydride), tribasic calcium phosphate, tricalcium phosphate, a-type tricalcium phosphate, β-type tricalcium phosphate, hydroxyapatite, tetracalcium phosphate, calcium pyrophosphate, and calcium dihydrogen pyrophosphate. Among these, hydroxyapatite is more preferable.

Hydroxyapatite has an OH⁻ group, and thus has an excellent reactivity with a metal oxide or alkoxysilane and is excellent in heat resistance as calcium phosphate. Therefore, hydroxyapatite is stable for a high-temperature heat treatment process. As a result, in the case of adopting the hydroxyapatite as calcium phosphate, core loss of the powder magnetic core may be effectively reduced. Furthermore, the hydroxyapatite has an advantage in that a part of ions in a structure thereof may be substituted with other elements as necessary.

It is preferable that a particle size of the metal oxide be 10 to 350 nm as an (average) particle size. When a metal oxide having a large particle size is used, an insulation property tends to be excellent. As a metal oxide having a small particle size is used, when a molded body is formed, the strength or density of the molded body tends to increase. Furthermore, metal oxides that have a different particle size may be used in combination from a viewpoint of improving a coverage factor of a surface of a metal powder, and a viewpoint of making a metal oxide layer relatively dense. When a fine metal oxide particulate is present between relatively large metal oxides that are deposited on the surface of the metal powder, an insulating material may be formed in a high density. In addition, at a convex portion and a curved portion of the surface of the metal powder, it is difficult to form a uniform film of a metal oxide having a particle size of 100 nm or more. At the convex portion and the curved portion at which it is difficult to form the film of the metal oxide, it is preferable to use a metal oxide having a particle size less than 100 nm, and more preferably 50 nm or less, thereby improving uniformity of a film.

It is preferable that the metal oxide include at least one selected from the group consisting of calcium oxide, magnesium oxide, aluminum oxide, zirconium oxide, iron oxide, silicon dioxide, titanium oxide, yttrium oxide, zinc oxide, copper oxide, and cerium oxide. In this case, the metal oxide is made to adhere to a surface of the metal powder together with the calcium phosphate, thereby forming a relatively uniform insulating layer. As a result, the magnetic characteristics of the powder magnetic core that is obtained may be increased. Among these, magnesium oxide, aluminum oxide, and zirconium oxide are preferable, and silicon dioxide is more preferable.

According to another aspect of the invention, there is provided a powder magnetic core that is formed by compressing and annealing the above-described coated metal powder. This powder magnetic core is free from strain that is applied to the metal powder, and thus hysteresis loss is reduced.

According to still another aspect of the invention, there is provided an electromagnetic apparatus including an iron core, and preferably including the above-described powder magnetic core. In this case, performance improvement and miniaturization of the electromagnetic apparatus may be realized. Examples of the electromagnetic apparatus include a converter of a hybrid vehicle or various electric vehicles, a system interconnection device of photovoltaic generation or wind power generation, and a high-frequency correspondence reactor that is used for an inverter of an air conditioner.

According to still another aspect of the invention, there is provided a method of producing the coated metal powder. The method includes: a step of reacting an aqueous solution containing a calcium ion and a phosphate ion, and metal powders containing iron as a main component to react with each other in the presence of a metal oxide to form an insulating layer on a surface of the metal powders; and a step of bringing an organosilicon compound into contact with the coated metal powders on which the insulating layer is formed to dispose the organosilicon compound on a surface of the insulating layer or inside the insulating layer.

According to the method of producing the coated metal powder, a water atomized powder, which is considered to form an insulating film containing iron as a main component with difficulty, is adaptable. Generally, in a pure iron powder such as the water atomized powder that has a distorted form, a sufficient specific resistivity cannot be obtained after a severe heat treatment process at a temperature of 600° C. or more with only an inorganic material or an organic material such as a resin. Therefore, complexation of the inorganic material and the organic material such as a resin that is excellent in heat resistance is considered to be preferable. A problem at the time of producing an insulating layer of an inorganic material is that a surface of the magnetic powder containing iron as a main component has a low adhesion property with respect to the inorganic material, and pure iron powder floats in water or an organic solvent, and therefore, when agitation is performed only by adding slurry of inorganic particulates, an adhesion amount to the surface of the iron powder becomes insufficient. Therefore, in a method in the related art, the inorganic material is mixed with the pure iron powder as a powder as is, or slurry is mixed with the iron powder (of a high concentration) in a minute amount with respect to an amount of iron powder, and the resultant mixture is agitated and dried to remove a solvent so as to form a film of the inorganic particulates in a forced manner. However, in the above-described method, naturally, it is difficult to form a uniform particulate film, and as a result, an insulation property of a powder magnetic core that is obtained is low, and the inorganic material that is adhered is easily peeled off.

With respect to this point, the method of producing the coated metal powder according to the present invention is particularly effective for a water atomized powder that forms an insulating film with difficulty, and a high insulation property may be expected with respect to the entirety of soft magnetic powders containing iron as a main component. Furthermore, the water atomized powder is not expensive and thus is suitable for mass productivity. In the water atomized powder in the related art, it is difficult to form a film that is excellent in heat resistance and an insulation property due to a distorted form thereof. For example, in regard to a pure iron powder, when using a spherical atomized powder, it is possible to have a high specific resistivity of several hundreds to several thousands even after annealing at 600° C. Conversely, when a water atomized powder in Patent Literature 3 is used, a specific resistivity after annealing (600° C.) is only approximately 0.7 to 44 μΩm.

In addition, in the related art, an oxide of a rare-earth element or a transition metal, and the like, and an aqueous solution of phosphoric acid are mixed to form calcium phosphate on a surface of a metal powder. However, in the present invention, intended calcium phosphate is formed by allowing a phosphate ion and an aqueous solution in which cations are dissolved to react with each other under an alkali environment without using the phosphoric acid. Therefore, since a reaction system is in an alkali environment, the surface of the metal powder is not oxidized, and there is a little concern of as reduction in magnetic characteristics.

Furthermore, in the present invention, the process of forming the insulating layer using the calcium phosphate and the metal oxide may be continuously performed in water or various organic solvents, and thus it is possible to form an inorganic particulate film that is more uniform than that in a known metal powder coating method.

According to still another aspect of the invention, there is provided a method of producing a powder magnetic core. The method includes compressing and annealing the coated metal powder that is obtained by the above-described method. The powder magnetic core that is obtained in this manner exhibits relatively excellent magnetic characteristics.

### Advantageous Effects of Invention

According to the present invention, even when using a powder in which unevenness is formed and which has a distorted shape, it is possible to provide a powder magnetic core that is excellent in magnetic characteristics or mechanical characteristics, a coated metal powder that is used for producing the powder magnetic core, and a method of producing the same.

### BRIEF DESCRIPTION OF DRAWINGS

FIG. 1 is a SEM image (magnification of 2,000 times) of a coated iron powder that is obtained by Example 4.

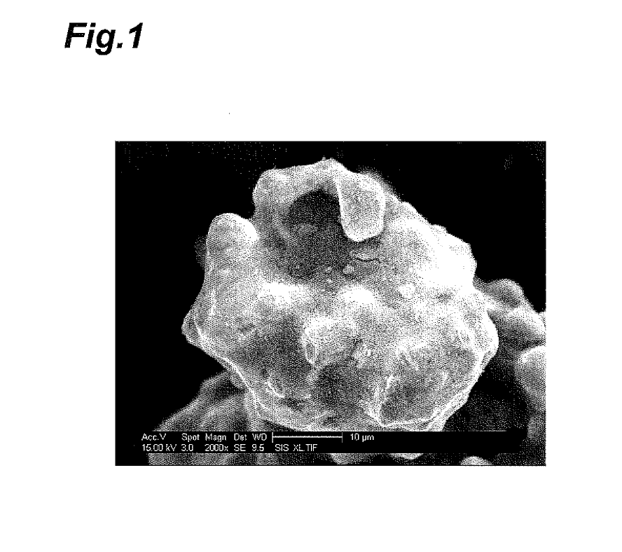

FIG. 2 is a SEM image (magnification of 20,000 times) of the coated iron powder that is obtained by Example 4.

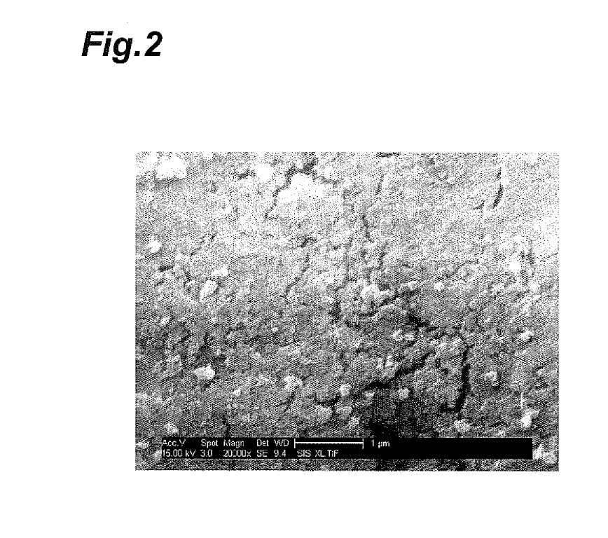

FIG. 3 is a SEM image (magnification of 1,000 times) of a coated iron powder that is obtained by Example 21.

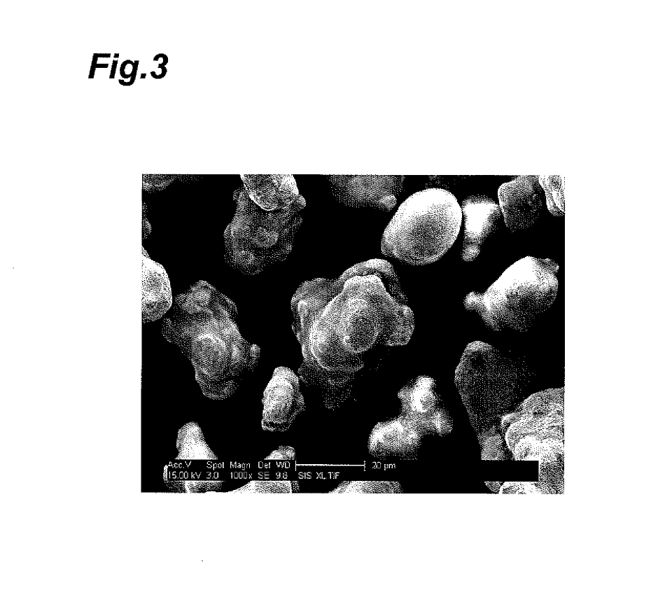

FIG. 4 is a SEM image (magnification of 20,000 times) of the coated metal powder that is obtained by Example 21.

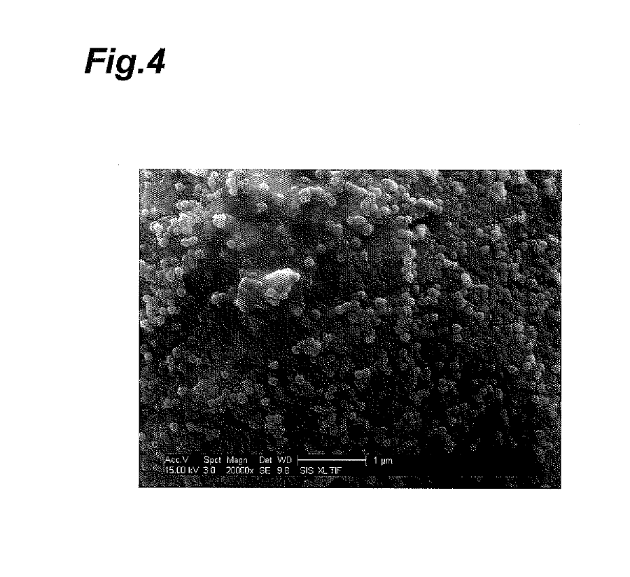

### DESCRIPTION OF EMBODIMENTS

Hereinafter, preferred embodiments of the present invention will be described in detail.

A coated metal powder includes a metal powder containing iron as a main component, and an insulating layer that is formed on a surface of the metal powder and is formed from calcium phosphate and a metal oxide, in which an organosilicon compound is contained on a surface of the insulating layer or inside the insulating layer.

In addition, a method of producing the coated metal powder includes a step of allowing an aqueous solution containing calcium ions and phosphate ions, and metal powders containing iron as a main component to react with each other in the presence of a metal oxide to form an insulating layer on a surface of the metal powders, and a step of bringing an organosilicon compound into contact with the coated metal powders on which the insulating layer is formed to dispose the organosilicon compound on a surface of the insulating layer or inside the insulating layer.

Here, a layer that is formed on a surface of the metal powder and is formed from the calcium phosphate and the metal oxide is referred to as “insulating layer”, and an insulating layer containing the organosilicon compound on the surface of the insulating layer or inside the insulating layer is referred to as “organosilicon treated insulating layer”. Furthermore, originally, it is ideal that powder particles of calcium phosphate or the like that are contained in the insulating layer are formed for each powder. However, actually, a layer may be formed in a state in which several particles are solidified, and even when this state, there is no problem on a characteristic aspect. Hereinafter, respective constituent elements are sequentially described.

The metal powder containing iron as a main component represents a powder that is formed from pure iron, and a powder that is formed from an iron alloy in which in the metal content, iron has the highest content. Examples of the metal powder containing iron as a main component include an iron powder, a silicon steel powder, a Sendust powder, a permendur powder, an iron-based amorphous magnetic alloy powder (for example, Fe—Si—B-based), and a soft magnetic material such as a permalloy powder. These powders may be used alone or in combination of two or more kinds. Among these, the pure iron powder is preferable because the pure iron is excellent in magnetic characteristics (ferromagnetism and a high saturation magnetic flux density) and is available cheaply. The pure iron powder may be a water atomized powder having a distorted shape. Generally, the metal powder includes 0 to 10% by mass of Si on the basis of 100% by mass of the total mass of the metal powder, and a remainder. The remainder includes (1) Fe that is a main component, (2) modifying elements such as Al, Ni, and Co that are added to improve magnetic characteristics, and (3) inevitable impurities.

Examples of the inevitable impurities include an impurity contained in a raw material (molten metal) of the metal powder, an impurity that is mixed in during powder forming, and the like. These impurities are elements that are difficult to remove due to a cost aspect or a technical aspect. In the case of the metal powder relating to the present invention, for example, C, S, Cr, P, Mn, and the like may be exemplified. In addition, naturally, a kind of basic elements (Fe, Co, Ni, Si, and the like) and a composition thereof are important for the metal powder, and thus a proportion of the modifying elements or the inevitable impurities is not particularly limited.

As the metal powder, the pure iron powder is particularly preferable because the pure iron powder is excellent in a saturation magnetic flux density, permeability, and compressibility. Examples of the pure iron powder include an atomized iron powder, a reducing iron powder, an electrolytic iron powder, and the like. For example, 300 NH manufactured by Kobe Steel, Ltd, KIP-MG270H or KIP-304AS manufactured by Kawasaki Steel Corporation, and an atomized pure iron powder (trade name: ABC100.30) manufactured by Hoganas AB, and the like may be exemplified.

A method of producing the metal powder does not matter. A crushed powder or an atomized powder is possible, and any one of the atomized powder, a water atomized powder, a gas atomized powder, and a gas and water atomized powder is possible. The water atomized powder has the most preferable availability and is cheap. The water atomized powder has a distorted particle shape, and thus easily improves the mechanical strength of a green compact that is obtained by compression molding the water atomized powder, but it forms a uniform insulating layer with difficulty and it is difficult to obtain a high specific resistivity. On the other hand, the gas atomized powder is a pseudo-spherical powder having an approximately spherical shape. Since the shape of each particle is approximately a spherical shape, when soft magnetic powders are compression-molded, an aggression property between respective powder particles becomes low, and thus breakage and the like of the insulating layer is suppressed. Therefore, it is easy to obtain a powder magnetic core having a high specific resistivity in a stable manner.

In addition, since the gas atomized powder has an approximately spherical shape, a surface area thereof is smaller than that of the water atomized powder or the like that has a distorted particle shape. Therefore, even when the total amount of particulates making up the organosilicon-treated insulating layer is the same, when using the gas atomized powder, a relatively thick insulating layer may be formed, and thus it is easy to further reduce eddy current loss. Conversely, an insulating layer having the same film thickness is provided, the total amount of the organosilicon-treated insulating layer may be reduced and thus a magnetic flux density of the powder magnetic core may be increased. Furthermore, since in the gas atomized powder, a grain size in the powder particles is large, a coercive force becomes small and thus reduction in hysteresis loss is easily realized. Therefore, when using a pseudo-spherical powder like the gas atomized powder, improvement in magnetic characteristics and reduction in core loss may be compatible with each other. Absolutely, the soft magnetic powder may be a powder other than the atomized powder, and for example, may be a crushed powder that is obtained by crushing an alloy ingot using a ball mill or the like. When this crushed powder is subjected to a heat treatment (for example, annealing at 800° C. or more in an inert atmosphere), a grain size may be enlarged.

As the metal powder, a metal powder, which is treated with a phosphoric acid to prevent oxidation, may be used. When using the metal powder that is subjected to this treatment in advance, it is possible to prevent a surface of the metal powder from being oxidized. The phosphoric acid treatment may be performed by method disclosed in Japanese Unexamined Patent Application Publication No. 7-245209, Japanese Unexamined Patent Application Publication No. 2000-504785, and Japanese Unexamined Patent Application Publication No. 2005-213621, and a metal powder that is available on the market as a metal powder that is treated with phosphoric acid may be used.

A particle size of the metal powder is not particularly limited, and is appropriately determined depending on a use or requested characteristics of the powder magnetic core. Generally, the particle size may be selected in a range of 1 to 300 μm. When the particle size is 1 μm or more, there is a tendency that the powder magnetic core is easy to be molded at the time of producing the same, and when the particle size is 300 μm or less, it is possible to suppress an increase of an eddy current of the powder magnetic core and there is a tendency that the calcium phosphate may be easily formed. In addition, as the particle size (calculated by a sieve analysis method), 50 to 250 μm is preferable. A form of the metal powder is not limited, and a powder with a spherical form or a massive form, or a flat-shaped powder that is processed to be flat by a known method or a mechanical treatment may be used.

Next, the organosilicon-treated insulating layer will be described. The film thickness of the organosilicon-treated insulating layer is preferably 10 to 1,000 nm, more preferably 30 to 900 nm, and still more preferably 50 to 300 nm. When the film thickness of the organosilicon-treated insulating layer is too small, the specific resistivity of the powder magnetic core becomes small and thus the core loss cannot be reduced sufficiently. On the other hand, when the film thickness and the like of the organosilicon-treated insulating layer are too large, a decrease in magnetic characteristics of the powder magnetic core may be caused. Hereinafter, respective configurations of the calcium phosphate, the metal oxide, and the organosilicon compound will be sequentially described.

The calcium phosphate that covers the surface of the metal powder mainly has a function as an insulating film of the metal powder. In addition, when the calcium phosphate is formed, a metal oxide to be described later may be formed on the surface of the metal powder. From this viewpoint, it is preferable that the calcium phosphate have a film structure covering the surface of the metal powder as a layer state. The insulating film formed from the calcium phosphate may be formed on any powder as long as the powder is a metal powder.

In regard to a degree of coating the metal powder with the calcium phosphate, a part of metal powders may be exposed, but it is preferable that a coverage factor be high because, a specific resistivity value (index of an insulation property) of the powder magnetic core at the time of molding the powder magnetic core is raised with a high coverage factor, and a metal oxide or an organosilicon compound that is described later is easily adhered to the metal powder, and as a result, a transverse rupture strength is also improved. Specifically, it is preferable that 90% or more of the surface of the metal powder be coated with two or more kinds of inorganic materials including the calcium phosphate and the metal oxide, more preferably 95% or more, and still more preferably the entirety of the surface (approximately 100%).

It is preferable that the thickness of the insulating film formed from the calcium phosphate be 10 to 1,000 nm, and more preferably 20 to 500 nm. When the thickness is 10 nm or more, there is a tendency of obtaining an insulation effect, and when the thickness is 1,000 nm or less, a density of a molded body is not decreased greatly.

It is preferable that an amount of the calcium phosphate that is formed on the surface of the metal powder be 0.1 to 1.5 parts by mass on the basis of 100 parts by mass of the metal powder, and more preferably 0.4 to 0.8 parts by mass. When the amount is 0.1 parts by mass or more, improvement in an insulation property (specific resistivity) and an adhesion operation of the metal oxide to be described later may be obtained. When the amount is 1.5 parts by mass or less, when the metal powder is molded into a powder magnetic core, a decrease in a density of a molded body tends to be prevented. A mass of the calcium phosphate may be obtained by measuring a mass increase of the coated metal powder that is obtained.

Examples of the calcium phosphate include monobasic calcium phosphate {Ca(H₂PO₄)₂.0 to 1H₂O}, dibasic calcium phosphate (anhydride) (CaHPO₄), dibasic calcium phosphate {CaHPO₄.2H₂O}, tribasic calcium phosphate {3Ca₃(PO₄)₂.Ca(OH)₂}, tricalcium phosphate {Ca₃(PO₄)₂}, α-type tricalcium phosphate {α-Ca₃(PO₄)₂}, β-type tricalcium phosphate {β-Ca₃(PO₄)₂}, hydroxyapatite {Ca₁₀(PO₄)₆(OH)₂}, tetracalcium phosphate {Ca₄(PO₄)₂O}, calcium pyrophosphate (Ca₂P₂O₇), calcium dihydrogen pyrophosphate (CaH₂P₂O₇). Among these, the hydroxyapatite that is excellent in heat resistance is preferable. In addition, since the hydroxyapatite has an Off group in a structure, reactivity with a metal oxide and an organosilicon compound is excellent.

The hydroxyapatite is one type of the calcium phosphate, and is expressed by a chemical formula: Ca₁₀(PO₄)₆(OH)₂. In regard to the hydroxyapatite shown in the present invention, a part in a structure thereof may be substituted with other elements. In the case of precipitating the hydroxyapatite as calcium phosphate, a stoichiometric compositional formula of the hydroxyapatite that is obtained is Ca₁₀(PO₄)₆(OH)₂, but most of the hydroxyapatite has an apatite structure, and as long as this structure may be maintained, a nonstoichiometric composition like a Ca-deficient hydroxyapatite is possible. That is, in the present invention, it is considered that hydroxyapatite having a nonstoichiometric composition like the Ca-deficient hydroxyapatite is included in the above-described hydroxyapatite. Specifically, theoretical hydroxyapatite is formed in a molar ratio of Ca/P=1.66, but Ca/P may be 1.4 to 1.8.

In addition, a part of ions in a structure of the hydroxyapatite may be substituted with other elements within a range not deteriorating a property. An apatite compound represented by the hydroxyapatite is a composition expressed by the following general formula (I), and various compound combinations are present through substitution of M²⁺, ZO⁴⁻, and X⁻. A case in which X⁻ is OH⁻ is particularly referred to as hydroxyapatite.

M₁₀(ZO₄)₆X₂ (I)

In the general formula (I), an ion of metal, which may be substituted with calcium, enters a position of M²⁺ that gives a cation ion, and specifically ions of sodium, magnesium, potassium, aluminum, scandium, titanium, chromium, manganese, iron, cobalt, nickel, zinc, strontium, yttrium, zirconium, ruthenium, rhodium, palladium, silver, cadmium, indium, tin, antimony, tellurium, barium, lanthanum, cerium, praseodymium, neodymium, samarium, europium, gadolinium, terbium, dysprosium, holmium, erbium, thulium, ytterbium, lutetium, hafnium, platinum, gold, mercury, thallium, lead, bismuth, and the like may be exemplified. In addition, PO₄³⁻, CO₃²⁻, CrO₄³⁻, AsO₄³⁻, VO₄³⁻, UO₄³⁻, SO₄²⁻, SiO₄⁴⁻, GeO₄⁴⁻, or the like enters a position of ZO₄⁻. OH⁻, a halide ion (F⁻, Cl⁻, Br⁻, and I⁻), BO²⁻, CO₃²⁻, O²⁻, or the like enters a position of X. In addition, an ion that is substituted for M²⁺, ZO₄⁻, and X⁻ may be one kind or two kinds or more.

Here, it is preferable that the X be OH⁻ or F⁻. In the case of OH⁻, this is preferable because a hydrophilic property is increased, and thus a coating property with respect to the metal powder is excellent. In the case of F—, this is preferable because the strength is excellent. That is, it is particularly preferable to use hydroxyapatite: Ca₁₀(PO₄)₆(OH)₂ or fluoroapatite: Ca₁₀(PO₄)₆F₂ because when a powder magnetic core is made, an insulation property, a heat resistance, and dynamic characteristics are excellent.

In a case where calcium is substituted with another atom, it is preferable that a substitution degree (the number of moles of another substituting atom/the number of moles of calcium) of each component by another element be 30% or less. Similarly, even in a case where the phosphate ion is substituted, it is preferable that the substitution degree be 30% or less, but in regard to a hydroxyl group, 100% of the hydroxyl groups may be substituted with another atom. The calcium phosphate may be obtained by allowing a solution containing calcium ions (in the case of containing atoms other than calcium atoms, an ion of the atom M that yields a cation other than the calcium ions and that will be described later) and an aqueous solution containing phosphate ions to react with each other. In a case where instead of the calcium ions, the ion of the atom M to be described later is allowed to react, calcium phosphate (an apatite compound or the like) in which a position of the atom M²⁺ that yields a cation is substituted with the ion of the atom M in general formula (I) may be obtained.

In the case of allowing the phosphate compound to precipitate on a surface of metal powders, first, an aqueous solution, which contains calcium ions and which is subjected to a pH adjustment in an alkali environment, and metal powders are put into a vessel formed from metal, plastic, glass, or the like, and then an aqueous solution containing phosphate ions is added to the resultant mixture, thereby preparing an aqueous solution in which pH is 7 or more and the Ca/P ratio is in a preferable ratio after being mixed. After adjustment of the aqueous solution, it is preferable that mixing with the aqueous solution be performed while crushing the metal powders in the aqueous solution. In this case, an addition order may be changed, that is, the aqueous solution containing calcium ions may be added after the aqueous solution containing the phosphate ions and the metal powder are put into the vessel. In addition, the aqueous solution containing the phosphate ions, the metal powders, and the calcium ions may be put into the vessel at the same time.

The calcium ions are not particularly limited as long as the calcium ions are derived from a calcium compound. Specifically, for example, as a calcium ion source, a calcium salt of an inorganic base such as calcium hydroxide, a calcium salt of an inorganic acid such as calcium nitrate, a calcium salt of an organic acid such as calcium acetate, a calcium salt of an organic base, and the like may be exemplified. As a phosphoric acid source, phosphoric acid, phosphate such as ammonium dihydrogen phosphate and diammonium hydrogen phosphate, a condensed phosphoric acid such as a pyrophosphoric acid (diphosphoric acid) and a metaphosphoric acid may be exemplified. Among these phosphate compounds, any phosphoric compound may be used as long as this phosphate compound may be precipitated by allowing phosphoric acid and a salt (nitrate, acetate, carbonate, sulfate, chloride, or hydroxide) that yields a calcium ion to react. In addition, when considering impurities that are mixed in, it is particularly preferable to perform the precipitation by using the ammonium phosphate.

A reaction solution that is used during forming calcium phosphate on a surface of the metal powders is preferably in a neutral region to a base region. In this manner, the surface of the metal powders may be prevented from being oxidized, and among calcium phosphates, particularly, hydroxyapatite may be formed. It is preferable that the reaction solution during the formation have pH 7 or more, more preferably 8 to 11, and further more preferably 10 to 11 even when considering a solubility product of calcium phosphates. The hydroxyapatite dissolves in an acid region, and calcium phosphate other than hydroxyapatite is precipitated or mixed in a neutral region. In addition, in the acid region, in accordance with a kind of metal powder, the hydroxyapatite may be oxidized and thus a part thereof is converted into an oxide. As a result, rust is generated and thus a color thereof is changed. Therefore, it is necessary for the pH of the reaction solution to be correctly adjusted by using a base such as aqueous ammonia, sodium hydroxide, and potassium hydroxide.

The crushing represents that during agitation, an aggregated portion of the metal powders is made to be loosened by using a shearing force that is applied to the metal powders due to friction or collision between metal powders. As a method of mixing an aqueous solution containing metal powders while crushing the metal powders, any one of methods using a planetary-mixer, a ball mill, a bead mill, a jet mill, a mix rotor, an evaporator, ultrasonic dispersion, and the like, which are capable of performing wet-type agitating (mixing), may be exemplified. Among these, it is preferable that the agitating be performed in accordance with a sample by adjusting the number of rotations by a mix rotator. Among the metal powders, an iron powder for a powder magnetic core is manufactured by an atomized method, and has a relatively wide particle size distribution. Therefore, a coarse iron powder that is insufficiently crushed or aggregation between iron powders is shown. When the coarse powder is mixed in, a decrease in magnetic characteristics or a density of a molded body may be caused. Therefore, it is possible to coat the metal powders with calcium phosphate while preventing the magnetic characteristics or the density of the molded body from being decreased by performing the agitating.

In regard to an agitating speed, even though the optimal rotation speed varies depending on the volume of a vessel that is used, the mass or the appearance volume of metal powders, or the volume of an aqueous solution, but for example, in a case where the volume of the vessel is 1,000 cm³, the weight of the metal powders that are used is 300 g, and the volume of the aqueous solution is 120 to 130% of the appearance volume of the metal powders, 30 to 300 rpm is preferable, and 40 to 100 rpm is more preferable. At this time, accompanying the rotation of the vessel, it is necessary for the metal powders to flow on an inner wall of the vessel. However, when the agitating speed is 300 rpm or higher, the metal powders do not flow and rotate while being adhered to the inner wall. As a result, the agitation is not performed in an effective manner. On the other hand, when the agitating speed is lower than 30 rpm, the vessel rotates too slowly, and thus the metal powders temporary stay on the bottom (the lowest position during agitation) of the vessel due to their own weight, and thus the agitation is not performed at all.

Even when a reaction temperature during forming calcium phosphate on a surface of the metal powders is room temperature, there is no particular problem. However, when the temperature is raised, the reaction is promoted and thus a time that is necessary for the formation may be shortened. As the reaction temperature, 50° C. or higher is preferable, and 70° or higher is more preferable.

A reaction time during forming the calcium phosphate on the surface of the metal powders is different depending on the concentration of an aqueous solution containing calcium ions and the concentration of an aqueous solution containing phosphate ions. The concentrations of the solutions containing respective ions are preferably in a range of 0.003 to 1.0 M, respectively. The concentrations of the solutions containing respective ions are preferably in a range of 0.001 to 2.0 M, respectively, and more preferably in a range of 0.1 to 1.0 M. A reaction time in this case is preferably 1 to 10 hours, and more preferably 2 to 5 hours. In the case of 2.0 M or more, the metal powders easily aggregate with each other, and thus a low density is problematic when a molded body is produced. On the other hand, in the case of 0.01 M or less, the reaction time is lengthened more than necessary, and thus uniform coating of the metal powders may be difficult depending on a selected material. In addition, when the reaction time is short, for example, for approximately 1 to 10 minutes, the intended calcium phosphate is insufficiently generated on the surface of the metal powders, and thus a decrease in a yield rate and deficiency of insulation property (specific resistivity) are caused.

As an amount of an aqueous solution during forming the calcium phosphate on the surface of the metal powders, an amount with which the metal powders may effectively flow together with the rotation of the vessel is necessary. Therefore, it is preferable that the amount be 100 to 200% of the appearance volume with metal powders that are used, more preferably 110 to 140%, and still more preferably 120 to 130%.

Next, a metal oxide will be described. During forming the calcium phosphate on the surface of the metal powders in water or after forming the calcium phosphate, the metal oxide relating to the present invention is added to the aqueous solution, thereby forming the metal oxide on the surface of the metal powders. The metal oxide is formed mainly on the calcium phosphate, but a part thereof may be formed inside the calcium phosphate or on the surface of the metal powders. When a uniform insulating layer of an inorganic material is formed by using the above-described calcium phosphate and the metal oxide, a high specific resistivity may be obtained.

The metal oxide may be used in a powder form, but it is preferable to use the metal oxide in a slurry state. That is, it is preferable that the metal oxide be dispersed in a solvent (water or an organic solvent) without being aggregated. In a step of forming the metal oxide on the surface of the metal powder, the addition of the metal oxide may be performed during forming the calcium phosphate or after this formation. This means that the coating of the metal powders with the calcium phosphate is performed using water as a solvent, and thus a sequence of dropping the metal oxide is not particularly limited. When the metal oxide is added during the formation, the calcium phosphate and the metal oxide are mixed, and thus the calcium phosphate and the metal oxide are uniformly distributed over the entirety of the iron powders, and a dense layer is formed. On the other hand, the metal oxide is added after forming the calcium phosphate layer, a fine metal oxide film is formed on the surface of the calcium phosphate layer. Particularly, the metal oxide is adhered in a concentrated manner to a surface portion on which unevenness, which easily causes cracking at the time of producing a molded body, is formed, and thus an effect as a buffer material is relatively increased.

Examples of the metal oxide include aluminum oxide, titanium oxide, cerium oxide, yttrium oxide, zinc oxide, silicon oxide, tin oxide, copper oxide, holmium oxide, bismuth oxide, cobalt oxide, indium oxide, and the like. These metal oxides may be used alone or in combination of two or more kinds. In addition, this metal oxide may be added in a powder state, but it is preferable to add the metal oxide in a slurry state. Intended metal oxide powders are dispersed in an appropriate solvent (water or an organic solvent) and the resultant dispersed mixture is used, thereby forming a uniform particulate film.

A method of dispersing the metal oxide is not particularly limited, but specifically, a crushing method using a bead mill, a jet mill, or the like, an ultrasonic dispersion, and the like may be exemplified. In addition, a product available on the market as a slurry may be used as is. Examples of the form of the metal oxide include various forms such as a spherical form and a potbelly form, but the form is not particularly limited. As a specific product of a slurry product, NanoTek Slurry series manufactured by CI Kasei Co., Ltd., Quartron PL series or SP series that are manufactured by FUSO CHEMICAL CO., LTD., Snowtex series (colloidal silica and organosol), alumina sol, and Nano-Use that are manufactured by Nissan Chemical Industries, Ltd., Admafine manufactured by ADMATECHS CO., LTD., and the like may be exemplified.

As a particle size of the metal oxide, various sizes are possible, but a sub-micron particle size or less is preferable for a film forming property. An (average) particle size of the metal oxide may be measured by instrumental analysis such as a dynamic light scattering method and a laser diffraction method. In addition, the (average) particle size may be measured by directly observing fine metal oxide formed on the surface of the calcium phosphate using an electron microscope such as a SEM, an optical microscope, or the like. When directly observing, for example, ten metal oxide particles are arbitrarily selected in one sheet of a scanning electron microscope photograph, measurement values of the respective ten metal oxide particles are obtained, and the sum of the respective measurement values is divided by ten and this resultant value is referred to as an “average” particle size. Hereinafter, it is simply described as a particle size.

It is preferable that the particle size of the metal oxide be 10 to 350 nm as an (average) particle size. When a metal oxide having a large particle size is used, an insulation property tends to be excellent. When a metal oxide having a small particle size is used, when a molded body is formed, the strength and a density of the molded body tend to increase. Furthermore, metal oxides that have a different particle size may be used in combination from a viewpoint of improving a coverage factor of the surface of metal powders, and a viewpoint of making a metal oxide layer relatively dense. When a metal oxide particulate is present between relatively large metal oxides that are deposited on the surface of the metal powders, an insulating material may be formed with a high density. In addition, at a convex portion and a curved portion of the surface of the metal powders, it is difficult to form a uniform film of a metal oxide having a particle size of 100 nm or more. At the convex portion and the curved portion at which it is difficult to form the film of the metal oxide, it is preferable to use a metal oxide having a particle size less than 100 nm, and more preferably 50 nm or less, thereby improving uniformity of a film.

The solvent that disperses the metal oxide is not particularly limited, and specific examples thereof include alcohol-based solvents represented by methanol, ethanol, isopropyl alcohol, and the like, a ketone-based solvent represented by acetone and methyl ethyl ketone, and an aromatic solvent represented by toluene. Furthermore, even when water is used, there is no problem.

In addition, it is preferable that an addition amount of the metal oxide be 0.05 to 2.0 parts by mass on the basis of 100 parts by mass of the metal powders that are used. When the addition amount is 0.05 parts by mass or more, there is a tendency that the metal powders may be uniformly coated with the metal oxide and thus an effect of improving an insulation property (specific resistivity) may be obtained. On the other hand, when the addition amount is 2.0 parts by mass or less, when being used as a powder magnetic core, there is a tendency that a density of a molded body is prevented from being decreased and thus a transverse rupture strength of the powder magnetic core that is obtained is also prevented from being decreased.

Next, the organosilicon compound will be described. A first aspect of the organosilicon compound is an alkoxysilane or a reaction product thereof. The alkoxysilane or the reaction product thereof is formed on the surface of the metal powders containing iron as a main component or inside the metal powders, and on a surface of an insulating layer that is formed on the surface of the metal powders or inside the insulating layer. When an alkoxy group of alkoxysilane, an OH⁻ group in a structure of hydroxyapatite, and an OH⁻ group on a surface of a metal oxide are hydrolyzed, hydrolysate of the alkoxysilane and/or a hydrolysis condensate of the alkoxysilane, which are reaction products, are formed on the surface of the insulating layer or inside the insulating layer. In this case, it is considered that the alkoxysilane, and hydroxyapatite and the metal oxide may be strongly bonded to each other. Therefore, the powder magnetic core formed from this coated metal powder exhibits a relatively excellent insulation property and mechanical characteristics.

As the alkoxysilane, various compounds from a low-molecular weight compound to a high-molecular weight compound may be used, and any compound may be used as long as the compound has an effect of improving the specific resistivity and strength of a molded body that is obtained. The alkoxysilane has a function (a binder component) of strongly bonding an inorganic material and the surface of the metal powder, and the coated metal powders to each other. Furthermore the alkoxysilane functions as a lubricant during compression molding to manufacture a molded body and thus serves to prevent the insulating layer from being broken due to excessive stress. Therefore, the alkoxysilane is effective in improving the strength of the powder magnetic core or to decrease eddy current loss. On the other hand, a high specific resistivity is exhibited only with an inorganic material in which the binder component such as the alkoxysilane is not used, but magnetic characteristics thereof are very low.

The alkoxysilane effectively serves not only for improvement in the strength of the powder magnetic core but also for improvement in the specific resistivity thereof. The alkoxysilane causes the inorganic material such as the calcium phosphate and the metal oxide to adhere to the surface of the metal powders and then covers the surface, thereby giving the above-described effect with respect to the powder magnetic core. In addition, the alkoxysilane may be simultaneously added together with a solution containing metal oxide particulates, and may be agitated and mixed, whereby both of the alkoxysilane and the metal oxide particulates may be simultaneously adhered to the surface of the metal powders. By performing this process plural times, a relatively uniform resin film may be formed. In addition, a annealing process may be performed to promote drying of the solvent or for a condensation reaction of the alkoxysilane, and the like.

As the alkoxysilane, a compound expressed by the following general formula (II) may be used.

R¹ₙSi(OR²)₄₋ₙ (II)

(In the formula, n represents an integer of 1 to 3, and R¹ and R² represent monovalent organic groups.)

In general formula (II), as R¹, specifically, a cyclohexyl group, a phenyl group, a benzyl group, a phenethyl group, an alkyl group of C₁ to C₆ (carbon number is 1 to 6), and the like may be exemplified. In addition, as R², a monovalent organic group may be exemplified, and specifically, a methyl group, an ethyl group, and the like may be exemplified.

Specific examples of the alkoxysilane expressed by general formula (II) include trimethoxy silanes such as methyl trimethoxy silane, ethyl trimethoxy silane, n-propyl trimethoxy silane, iso-propyl trimethoxy silane, n-butyl trimethoxy silane, tert-butyl trimethoxy silane, n-pentyl trimethoxy silane, n-hexyl trimethoxy silane, cyclohexyl trimethoxy silane, phenyl trimethoxy silane, benzyl trimethoxy silane, and phenethyl trimethoxy silane, triethoxy silanes such as methyl triethoxy silane, ethyl triethoxy silane, n-propyl triethoxy silane, iso-propyl triethoxy silane, n-butyl triethoxy silane, tert-butyl triethoxy silane, n-pentyl triethoxy silane, n-hexyl triethoxy silane, cyclohexyl triethoxy silane, phenyl triethoxy silane (PTES), benzyl triethoxy silane, and phenethyl triethoxy silane, dimethoxy silanes such as diphenyl dimethoxy silane, dimethyl dimethoxy silane, ethyl methyl dimethoxy silane, methyl n-propyl dimethoxy silane, methyl iso-propyl dimethoxy silane, n-butyl methyl dimethoxy silane, methyl tert-butyl dimethoxy silane, methyl n-pentyl dimethoxy silane, n-hexyl methyl dimethoxy silane, cyclohexyl methyl dimethoxy silane, methyl phenyl dimethoxy silane, benzyl methyl dimethoxy silane, and phenethyl methyl dimethoxy silane, diethoxy silanes such as dimethyl diethoxy silane, ethyl methyl diethoxy silane, diphenyl diethoxy silane, methyl n-propyl diethoxy silane, methyl iso-propyl diethoxy silane, n-butyl methyl diethoxy silane, methyl tert-butyl diethoxy silane, methyl n-pentyl diethoxy silane, n-hexyl methyl diethoxy silane, cyclohexyl methyl diethoxy silane, methyl phenyl diethoxy silane, benzyl methyl diethoxy silane, and phenethyl methyl diethoxy silane. These alkoxysilanes may be used alone or in combination of two or more kinds. Among these, an alkoxysilane having a phenyl group or a benzyl group in a structure is preferable. The alkoxysilane mostly remains as C, SiO₂, and the like even after annealing, and thus has excellent heat resistance.

As a solvent that dissolves the alkoxysilane, any solvent may be used as long as this solvent is capable of sufficiently dissolving the alkoxysilane. For example, an organic solvent, which is represented by a ketone-based solvent such as acetone and methyl ethyl ketone, an aromatic solvent such as benzene, xylene, and toluene, an alcohol-based solvent such as ethanol and methanol, and the like, may be used. In addition, two or more kinds of solvents that are arbitrarily selected from these may be used in combination with an appropriate combination. When the alkoxysilane reacts with trace water that is attached to the surface of the metal powders, hydrolysis proceeds, and thus a strong insulating film is formed on the surface. Water may be added as necessary for the purpose of promoting reaction.

It is preferable that an amount of the alkoxysilane be 0.01 to 3.0 parts by mass on the basis of 100 parts by mass of the metal powders, and more preferably 0.05 to 1.5 parts by mass. When the amount is 3.0 parts by mass or more, there is a tendency that a density of a molded body decreases significantly and a specific resistivity also decreases. On the other hand, when a proportion of alkoxide is too small, sufficient adhesion between metal powders and an effect of improving a specific resistivity cannot be obtained.

In regard to the alkoxysilane, the strength or heat resistance when a molded body is formed varies greatly depending on a functional group. In addition, the alkoxysilane may be dissolved in various solvents through substitution of the functional group. After being mixed, the solvent is dried through heating or wind dry, and curing and baking process may be performed in consideration of a property, a use, requested characteristics, and the like of the alkoxysilane that is used. A temperature during a heat treatment depends on a solvent that is used, but it is preferable that the heat treatment be performed at a temperature of 70 to 250° C. for approximately 10 to 300 minutes. The heat treatment may be performed either in air or in an inert gas (N₂, Ar, or the like) atmosphere.

A second aspect of the organosilicon compound is a silicone resin. It is preferable that the silicone resin contains at least one compound of (1), (2), and (3) described below. (1) Polyorganosiloxane including a bifunctional siloxane unit (D unit) (for example, polydimethyl siloxane and polymethyl phenyl siloxane).

(2) A mixture of a polyorganosiloxane including at least one of a monofunctional siloxane unit (M unit), a trifunctional siloxane unit (T unit), and a tetrafunctional siloxane unit (Q unit) (for example, MQ resin including the M unit and Q unit), and a polyorganosiloxane including a bifunctional siloxane unit (D unit) (for example, polydimethyl siloxane and polymethyl phenyl siloxane) (this mixture may be a mixture having an adherence property at room temperature or a mixture in which the adherence property occurs when being heated). (3) A polyorganosiloxane including at least one of a monofunctional siloxane unit (M unit), a trifunctional siloxane unit (T unit), and a tetrafunctional siloxane unit (Q unit), and a bifunctional siloxane unit (D unit, for example, dimethyl siloxane unit, methyl phenyl siloxane unit) (it is preferable that the number of D units be larger than the total number of M units, T units, and Q units). As the polyorganosiloxane, an organosiloxane including at least one of a T unit and a Q unit, and a D unit is preferable.

As the silicone resin, a curable (particularly, thermosetting) silicone resin is preferable. A film formed from this silicone resin functions as an insulating film that covers a surface of an inorganic insulating material, but also as a binder that bonds constituent particles. A transformation temperature at which the silicone resin enters a gel state is different depending on a kind of silicone resin. Therefore, although not being specified, the transformation temperature is approximately 150 to 300° C. When heating is performed at this temperature, a silicone resin that is adhered to a particle surface of soft magnetic powders becomes a curable silicone resin film. In this silicone resin film, accompanying temperature increase, a siloxane bonding progresses. Therefore, entire crosslinking is obtained from partial crosslinking by performing a high-temperature heating treatment such as annealing, and thus film strength is improved. In addition, since the film formed from the silicone resin is excellent in heat resistance, even when high-temperature heating such as annealing is performed with the powder magnetic core after being molded, the powder magnetic core is not broken and the above-described crosslinking further progresses, and thus bonding between particles of a magnetic core powder is enhanced.

The silicone resins are largely classified into a thermosetting type that condenses and is cured by heat, and a room-temperature curing type that is cured at room temperature. In the former, when heat is applied, a functional group reacts and thus a siloxane bonding occurs, and thereby crosslinking progresses. As a result, the silicone resin condenses and is cured. On the other hand, in the latter, the functional group reacts at room temperature due to a hydrolysis reaction and thus the siloxane bonding occurs, and thereby the crosslinking progresses. As a result, the silicone resin condenses and is cured. The number of functional groups of a silane compound of the silicone resin is from 1 to a maximum of 4. The number of functional groups of the silicone resin that is used in the present invention is not limited, but it is preferable to use silicones including trifunctional or tetrafunctional silane compounds because a crosslinking density increases.

As a kind of silicone resins, starting from resins, silane compounds, rubber-based silicone, silicone powders, organic modified silicon oil, a composite thereof, and the like are exemplified, and a type thereof is different depending on a use. In the present invention, any silicone resin may be used. It is preferable to use a resin-based coating silicone resin, that is, a straight silicone resin including only silicone, or a silicone resin for modification that includes silicone and an organic polymer (alkyd, polyester, epoxy, acryl, or the like) from viewpoints of heat resistance, weather resistance, humidity resistance, an electrical insulation property, and simplicity of coating.

As the silicone resin, a methyl phenyl silicone resin in which a functional group on Si is composed of a methyl group or phenyl group is general. It is preferable that a lot of phenyl groups be contained because in this case, the heat resistance tends to increases. In addition, a ratio between a methyl group and phenyl group of the silicone resin and functionability may be analyzed by FT-IR or the like. Examples of the silicone resin that is used in the present invention include SH805, SH806A, SH840, SH997, SR620, SR2306, SR2309, SR2310, SR2316, DC12577, SR2400, SR2402, SR2404, SR2405, SR2406, SR2410, SR2411, SR2416, SR2420, SR2107, SR2115, SR2145, SH6018, DC6-2230, DC3037, DC3074, QP8-5314, and 217-Flake Resin that are manufactured by Dow Corning Toray Co., Ltd, YR3370, YR3286, TSR194, and TSR125R that are manufactured by Momentive Performance Materials Inc., KR251, KR255, KR114A, KR112, KR2610B, KR2621-1, KR230B, KR220, KR220L, KR285, K295, KR300, KR2019, KR2706, KR165, KR166, KR169, KR2038, KR221, KR155, KR240, KR101-10, KR120, KR105, KR271, KR282, KR311, KR211, KR212, KR216, KR213, KR217, KR9218, SA-4, KR206, KR5206, ES1001N, ES1002T, ES1004, KR9706, KR5203, KR5221, and X-52-1435 that are manufactured by Shin-Etsu Chemical Co., Ltd., and the like. In addition to these, other silicone resins may be used. In addition, a silicone resin obtained by modifying these materials or these raw materials may be used. Furthermore, a silicone resin, which is obtained by mixing two or more kinds of silicone resins in which a kind, a molecular weight, and a functional group are different in an appropriate ratio, may be used.

It is preferable to adjust an attached amount of a silicone resin film to be 0.01 to 0.8% by mass with respect to metal powders. When it is less than 0.01% by mass, an insulation property is deteriorated, and thus an electric resistance becomes low. On the other hand, when 0.8% by mass or more is added, powder after being heated and dried has a tendency to form a lump. In addition, a molded body that is manufactured by using lump-shaped powders is not likely to have a high density, and a film during molding is broken, whereby a decrease in eddy current loss becomes insufficient.

The silicone resin film may be formed by dissolving a silicone resin in petroleum-based organic solvents such as alcohols, ketones, toluene, and xylene, or the like, by mixing this resultant solution and iron powders, and by evaporating the organic solvent. A film forming condition is not particularly limited, but it is preferable to add 0.5 to 10 parts by mass of a resin solution, which is prepared in such a manner that a solid content is 0.5 to 5.0% by mass with respect to 100 parts by mass of magnetic powders coated with the insulating powders, and then mix the resultant material, and then dry the resultant mixture. When it is less than 0.5 parts by mass, there is a concern that the mixing may take a long time and the film may be non-uniform. On the other hand, when it exceeds 10 parts by mass, since an amount of solution is too much, there is a concern that the drying may take too much time or the drying becomes insufficient. The resin solution may be appropriately heated.

The thickness of the silicone resin film has a great effect on a decrease in a magnetic flux density. Therefore, 10 to 500 nm is preferable, and more preferably 20 to 200 nm. In addition, the total thickness of the inorganic insulating material and the silicone resin film is preferably 100 to 1,500 nm.

In regard to a step of drying the silicone resin, it is preferable to heat the silicone resin at a temperature at which an organic solvent that is used vaporizes and at a temperature lower than a curing temperature of the silicone resin so as to sufficiently vaporize the organic solvent. In regard to a specific drying temperature, the drying is performed at a temperature that is equal to or higher than a boiling temperature of each organic solvent. For example, as a specific example of the drying in the case of using a solvent such as ketones, drying by heating may be performed in a heating condition of 100 to 250° C. for 10 to 60 minutes. More preferably, the drying by heating may be performed at 120 to 200° C. for 10 to 30 minutes.

The drying process is performed to dry the resin film (remove the solvent) and preliminary cure the silicone resin. Due to this preliminary curing, flowability of magnetic powders may be secured during warm molding (approximately 100 to 250° C.). As a specific method, the magnetic powders on which the silicone resin film is formed are heated for a short time at a temperature near a curing temperature of the silicone resin. A difference between the preliminary curing and curing is that in the preliminary curing, powders are not bonded and solidified completely and are easily crushed, and conversely, in a high-temperature heating treatment process (annealing) that is performed after molding the powders, the resin is cured and powders are bonded and solidified, and thus the strength of the molded body is improved.

As described above, when the silicone resin is crushed after being subjected to the preliminary curing, it is possible to obtain powder that is excellent in flowability during being charged into a mold. When this preliminary curing is not performed, for example, powders are adhered to each other during the warm molding, and thus it is difficult to put the powders into the mold in a short time. In an actual process, an improvement in a handling property is very important, and it is found that a specific resistivity of a powder magnetic core that is obtained is improved by performing the preliminary curing. The reason is not clear, but it is considered to be because an adhesion property with iron powders during being cured is increased. In addition, as necessary, after being dried, the powders may be made to pass through a sieve having an aperture of approximately 50 to 500 μm so as to remove aggregated lumps.

(Manufacturing of Powder Magnetic Core)

The powder magnetic core may be obtained by a manufacturing method including a step of compressing and annealing the above-described coated metal powders. Here, the method of producing the powder magnetic core may include a step of mixing a lubricant with the coated metal powders as necessary, and compressing and annealing the resultant mixture. That is, the powder magnetic core may be obtained by mixing a lubricant with the coated metal powders as necessary and by compressing and annealing the resultant mixture. In addition, the lubricant may be used in such a manner that the lubricant is dispersed in an appropriate dispersion medium to obtain a dispersed solution, and then this dispersed solution is applied on an inner wall surface (a wall surface that comes into contact with a punch) of a mold dice, and is dried.

Prepared coated metal powders are formed into a molded body that is called a powder magnetic core through a filling process of filling the powders for a large magnetic core into a mold, and a molding process of compressing and molding the metal powders for a powder magnetic core. The compression molding of the coated metal powders (including the mixed powders), which are filled into the mold, for a powder magnetic core may be a general molding method in which an internal lubricant or the like is mixed with the powders, regardless of cold molding, warm molding and hot molding. However, it is more preferable to adopt a mold-lubricating warm compression molding method to be described later from a viewpoint of improving magnetic characteristics due to high densification. Due to this method, even when a molding pressure is set to be high, scuffing does not occur between an internal surface of the mold and the coated metal powders, and a taking-out pressure is not excessive, thereby suppressing a decrease in life time of the mold. In addition, a highly dense powder magnetic core may be produced in an industrial level not a test level.

As the lubricant, metallic soap such as zinc stearate, calcium stearate, and lithium stearate, long chain hydrocarbons such as wax, silicone oil, or the like may be used.

As a degree of compression in the molding process is appropriately selected depending on specifications of the powder magnetic core, a manufacturing facility, and the like, but in the case of using the mold-lubricating warm compression molding method, the molding may be performed under a high pressures higher than a molding pressure in the related art. Therefore, even in hard Fe—Si-based magnetic powders, a powder magnetic core having a high density may be easily obtained. The molding pressure may be, for example, 500 MPa or more, 1,000 MPa or more, 2,000 MPa, and 2500 MPa. When the molding pressure is high, a powder magnetic core having a high density may be obtained, but 2,000 MPa or less is sufficient. When high-pressure molding is performed at this pressure, a density of the powder magnetic core becomes close to a true density, and densification higher than this state is not expected. Therefore, it is preferable to perform the molding at a molding pressure of 700 to 1,500 MPa from a view point of life time of the mold or productivity.

When the coated metal powders are subjected to compression molding, remaining stress or remaining strain occurs inside the coated metal powders. Therefore, to remove these, a molded body is suitably subjected to a heat treatment process (annealing) of heating and gradually cooling the molded body. Due to this heat treatment process, hysteresis loss is reduced. In addition, a powder magnetic core, which is excellent in followability with respect to an alternating magnetic field or the like, may be obtained. In addition, the remaining strain or the like that is removed through the annealing process may be strain or the like that is accumulated inside the metal powders from before the molding process.

When the heat treatment temperature is high, the remaining strain or the like is effectively removed. At least partial breakage occurs even in an organosilicon-treated insulating layer that has the highest heat resistance. Therefore, it is preferable that the heat treatment temperature be determined by also considering a heat resistance in the organosilicon-treated insulating layer. For example, when the heat treatment temperature is set to 450 to 800° C., compatibility between the removal of the remaining strain and protection of the organosilicon-treated insulating layer may be realized. In consideration of an effect and economic efficiency, a annealing time is set to 1 to 300 minutes, and preferably 10 to 60 minutes.

An atmosphere at the time of performing the heat treatment, a non-oxidizing atmosphere is preferable. For example, a vacuum atmosphere, an inert gas (N₂, Ar) atmosphere, or a reducing gas (H₂) may be exemplified. In addition, the reason why the heat treatment process is performed in the non-oxidizing atmosphere is that excessive oxidization of the powder magnetic core or magnetic powder making up the powder magnetic core is suppressed and a decrease in magnetic characteristics or electrical characteristics is suppressed. Specifically, generation of FeO or generation of Fe₂SiO₄ layer may be exemplified.

The powder magnetic core that is manufactured by the above-described coated metal powders may be used for various electronic apparatuses such as a motor (particularly, a core or a yoke), an actuator, a reactor core, a transformer, an induction heater (IH), and a speaker. Particularly, in this powder magnetic core, a high magnetic flux density, and a decrease in hysteresis loss due to annealing or the like are realized. Furthermore, the powder magnetic core is applicable to an apparatus that is used in a relatively low frequency range, or the like.

It is preferable that a density of a molded body of the powder magnetic core be 7.0 g/cm³ or more, and more preferably 7.3 g/cm³. When the density is 7.3 g/cm³ or more, the magnetic flux density of the powder magnetic core tends to increase. The density (g/cm³) of the molded body may be calculated as (mass)/(volume) by measuring dimensions by a micrometer or the like and by measuring mass of the powder magnetic core. In addition, as another method, the density of the molded body may be determined by precision balance using an Archimedes' method.

An electric resistance value (specific resistivity) of the molded body of the powder magnetic core may be measured by a four-terminal method, a two-terminal method, or the like, but it is preferable that the measurement be performed by the four-terminal method. This is because at a position (between a current electrode and a sample surface) into which a constant current flows, a voltage drop called a contact resistance occurs due to an interfacial phenomenon, and it is desired to obtain a true volume resistivity of the sample by excluding the voltage drop. That is, in the four-terminal method, a current applying terminal and a voltage measuring terminal are separated, and thus an effect of the contact resistance is removed, whereby measurement with high accuracy may be performed.

In addition, in a four-probe method, four spicular electrodes (four probes) are linearly disposed on a sample and a constant current is made to flow between two outer probes, a potential difference that occurs between two inner probes is measured to obtain a resistance, and then a volume resistance is calculated by applying sample thickness and a correction coefficient to the obtained resistance. A measurement system is common to the four-probe method and four-terminal method, and only an electrode portion that comes into contact with the sample is different.

It is preferable that the electric resistance value (specific resistivity) of the powder magnetic core be 30 μΩm or more after being subjected to an annealing process at 600° C., more preferably 50 μΩm or more, and still more preferably 90 μΩm or more. When the electric resistance is 30 μΩm or more, it is considered that an insulation property of the powder magnetic core is maintained favorably, and there is a tendency that reduction effects both in hysteresis loss and reduction in eddy current loss are obtained.

### EXAMPLES

Hereinafter, examples of the present invention will be described, but the present invention is not limited by these examples.

### Example 1

30 g of pure iron powders (water atomized powders; KIP-304 AS, manufactured by Kawasaki Steel Corporation) was put into a 50 ml cylindrical polypropylene vessel, and 3.4 ml (0.358 M) of calcium nitrate aqueous solution, 10 ml of pure water, 0.5 ml of 25% aqueous ammonia, and 3.4 ml (0.215 M) of ammonium dihydrogen phosphate aqueous solution were added to the pure iron powders. Immediately after the addition, the vessel was covered with a lid, and the resultant mixture was agitated with a mix rotor in which the number of rotations was set to 40 rpm. After two hours, the vessel was opened, 2.0 g of ultrahigh purity colloidal silica (“Quartron PL-1” manufactured by FUSO CHEMICAL CO., LTD.; a particle size is 40 nm; and an SiO₂ concentration is 12% by mass) was added dropwise, and the vessel was covered again with a lid. Then the resultant mixture was agitated for 1.0 hour with the mix rotor in which the number of rotations was set to 40 rpm.

An iron powder dispersed solution after the agitation was subjected to suction filtration using No. 5C filter paper for quantitative analysis, and a filtered material was washed with acetone. The iron powders that were obtained were dried in a vacuum desiccator to obtain silica/hydroxyapatite coated iron powders (hereinafter, silica is referred to as “SiO₂” and hydroxyapatite is referred to as “HAP”).

Subsequently, 30 g of SiO₂/HAP coated iron powder was put into a 50 ml volume polypropylene vessel, a mixed solution of 0.23 g of phenyl triethoxy silane (manufactured by Shin-Etsu Chemical Co., Ltd.) (hereinafter, referred to as “PTES”)/2.0 g of ethanol was added dropwise, and then the resultant mixture was shaken in the vessel for 10 minutes. Then, the contents in the vessel were discharged into a stainless steel schale, and was subjected to preliminary curing at 200° C. for 30 minutes under atmospheric pressure.

7.0 g of the iron powders that were obtained was filled into a mold having an inner diameter of 14 mm, and was molded into a cylindrical tablet at a molding pressure of 1,000 MPa. At this time, the thickness of the tablet that was obtained was approximately 5 mm. As a lubricant, 1 mass % zinc stearate/ethanol solution was used, and this lubricant was applied on a wall surface of the mold. This tablet was annealed at 600° C. for one hour under a nitrogen atmosphere, a surface of a molded body was polished, and then a volume resistivity (specific resistivity) was measured by using a four-probe measuring device (RT-70/RG-5, manufactured by NAPSON CORPORATION) (the number n of measurement samples was 5). The specific resistivity of the molded body was 23.2 μΩm, and the density of the molded body was 7.39 g/cm³.

### Comparative Example 1

Coated metal powders that support only 0.6% of HAP were produced.

That is, 30 g of pure iron powders was put into a 50 ml cylindrical polypropylene vessel, and 5.0 ml (0.358 M) of calcium nitrate aqueous solution, 10 ml of pure water, 0.5 ml of 25% aqueous ammonia, and 5.0 ml (0.215 M) of ammonium dihydrogen phosphate aqueous solution were added to the pure iron powders. Immediately after the addition, the vessel was covered with a lid, and the resultant mixture was agitated with a mix rotor in which the number of rotations was set to 40 rpm.

An iron powder dispersed solution after the agitation was subjected to suction filtration using No. 5C filter paper for quantitative analysis, and a filtered material was washed with acetone. The iron powders that were obtained were dried in a vacuum desiccator to obtain HAP coated iron powders.

7.0 g of the iron powders that were obtained was filled into a mold having an inner diameter of 14 mm, and was molded into a cylindrical tablet at a molding pressure of 1,000 MPa. At this time, the thickness of the tablet that was obtained was 5 mm. As a lubricant, 1 mass % zinc stearate/ethanol solution was used, and this lubricant was applied on a wall surface of the mold. This tablet was annealed at 600° C. for one hour under a nitrogen atmosphere, a surface of a molded body was polished, and then a specific resistivity was measured (the number n of measurement samples was 5). The specific resistivity of the molded body was 0.03 μΩm, and the density of the molded body was 7.61 g/cm³.

### Comparative Example 2

Coated metal powders that support only 0.6% of SiO₂ were produced.

That is, 30 g of pure iron powders was put into a 50 ml cylindrical polypropylene vessel, and 1.5 g of SiO₂ was added dropwise to the iron powders, the vessel was covered again with a lid, and the resultant mixture was agitated with a mix rotor in which the number of rotations was set to 40 rpm. A solution after the agitation became cloudy even after passage of two hours, and thus it could be understood that in the metal powders not having a film formed from HAP, it is difficult to form a SiO₂ film.

### Comparative Example 3

Coated metal powders that were coated with only 0.75% of PIES was produced.

That is, 30 g of pure iron powders was put into a 50 ml cylindrical polypropylene vessel, a mixed solution of 0.23 g of PTES/2.0 g of ethanol was added dropwise to the iron powders, and the resultant mixture was shaken in the vessel for 10 minutes. Then, the contents in the vessel were discharged into a stainless steel schale, and was subjected to preliminary curing at 200° C. for 30 minutes under atmospheric pressure.

7.0 g of the iron powders that were obtained was filled into a mold having an inner diameter of 14 mm, and was molded into a cylindrical tablet at a molding pressure of 1,000 MPa. At this time, the thickness of the tablet that was obtained was 5 mm. As a lubricant, 1 mass % zinc stearate/ethanol solution was used, and this lubricant was applied on a wall surface of the mold. This tablet was annealed at 600° C. for one hour under a nitrogen atmosphere, a surface of a molded body was polished, and then a specific resistivity was measured (the number n of measurement samples was 5). The specific resistivity of the molded body was 0.01 μΩm, and the density of the molded body was 7.65 g/cm³.

### Comparative Example 4

Coated metal powders that support 0.6% of HAP and 0.6% of SiO₂ were produced.

That is, 30 g of pure iron powders was put into a 50 ml cylindrical polypropylene vessel, and 5.0 ml (0.358 M) of calcium nitrate aqueous solution, 10 ml of pure water, 0.5 ml of 25% aqueous ammonia, and 5.0 ml (0.215 M) of ammonium dihydrogen phosphate aqueous solution were added to the pure iron powders. Immediately after the addition, the vessel was covered with a lid, and the resultant mixture was agitated with a mix rotor in which the number of rotations was set to 40 rpm. After two hours, the vessel was opened, 1.5 g of SiO₂ was added dropwise, and the vessel was covered again with a lid. Then the resultant mixture was agitated for 1.0 hour with the mix rotor in which the number of rotations was set to 40 rpm.

An iron powder dispersed solution after the agitation was subjected to suction filtration using No. 5C filter paper for quantitative analysis, and a filtered material was washed with acetone. The iron powders that were obtained were dried in a vacuum desiccator to obtain SiO₂/HAP coated iron powders.

7.0 g of the iron powders that were obtained was filled into a mold having an inner diameter of 14 mm, and was molded into a cylindrical tablet at a molding pressure of 1,000 MPa. At this time, the thickness of the tablet that was obtained was 5 mm. As a lubricant, 1 mass % zinc stearate/ethanol solution was used, and this lubricant was applied on a wall surface of the mold. This tablet was annealed at 600° C. for one hour under a nitrogen atmosphere, a surface of a molded body was polished, and then a specific resistivity was measured (the number n of measurement samples was 5). The specific resistivity of the molded body was 3.0 μΩm, and the density of the molded body was 7.43 g/cm³.

### Comparative Example 5

Coated metal powders, which support 0.6% of HAP and which was coated with 0.75% of PTES, were produced.

That is, 30 g of pure iron powders was put into a 50 ml cylindrical polypropylene vessel, and 5.0 ml (0.358 M) of calcium nitrate aqueous solution, 10 ml of pure water, 0.5 ml of 25% aqueous ammonia, and 5.0 ml (0.215 M) of ammonium dihydrogen phosphate aqueous solution were added to the pure iron powders. Immediately after the addition, the vessel was covered with a lid, and the resultant mixture was agitated with a mix rotor in which the number of rotations was set to 40 rpm. An iron powder dispersed solution after the agitation was subjected to suction filtration using No. 5C filter paper for quantitative analysis, and a filtered material was washed with acetone. The iron powders that were obtained were dried in a vacuum desiccator to obtain HAP coated iron powders.

Subsequently, 30 g of the above-described hydroxyapatite coated iron powders was put into a 50 ml volume polypropylene vessel, a mixed solution of 0.23 g of PTES/2.0 g of ethanol was added dropwise to the resultant iron powders, and the resultant mixture was shaken in the vessel for 10 minutes. Then, the contents in the vessel were discharged into a stainless steel schale, and was subjected to preliminary curing at 200° C. for 30 minutes under atmospheric pressure.

7.0 g of the iron powders that were obtained was filled into a mold having an inner diameter of 14 mm, and was molded into a cylindrical tablet at a molding pressure of 1,000 MPa. At this time, the thickness of the tablet that was obtained was 5 mm. As a lubricant, 1 mass % zinc stearate/ethanol solution was used, and this lubricant was applied on a wall surface of the mold. This tablet was annealed at 600° C. for one hour under a nitrogen atmosphere, a surface of a molded body was polished, and then a specific resistivity was measured (the number n of measurement samples was 5). The specific resistivity of the molded body was 1.7 μΩm, and the density of the molded body was 7.48 g/cm³.

Example 1 and Comparative Examples 1 to 5 were collectively shown in Table 1. It was clear from Table 1, three components of calcium phosphate (hydroxyapatite: HAP), a metal oxide (SiO₂), and alkoxysilane (PTES) are requisite for obtaining a high specific resistivity.

TABLE 1

| | | | Application | | | |
|---|---|---|---|---|---|---|
| | Coating amount | Coating amount | amount of | Specific resistivity before | Specific resistivity after | Density of molded body |
| | of HAP (%) | of SiO₂ (%) | PTES (%) | annealing (μΩm) | annealing at 600° C. (μΩm) | (g/cm³) |
| Example 1 | 0.4 | 0.8 | 0.75 | 161 | 23.2 | 7.39 |
| Comparative | 0.6 | 0 | 0 | 76 | 0.03 | 7.61 |
| Example 1 | | | | | | |
| Comparative | 0 | 0.6 | 0 | SiO₂ film is not formed | | |
| Example 2 | | | | | | |
| Comparative | 0 | 0 | 0.75 | 182 | 0.01 | 7.65 |
| Example 3 | | | | | | |
| Comparative | 0.6 | 0.6 | 0 | 116 | 3.0 | 7.43 |
| Example 4 | | | | | | |
| Comparative | 0.6 | 0 | 0.75 | 111 | 1.7 | 7.48 |
| Example 5 | | | | | | |

Subsequently, coated metal powders were manufactured by changing a particle size of SiO₂.

### Example 2

30 g of pure iron powders was put into a 50 ml cylindrical polypropylene vessel, and 3.4 ml (0.358 M) of calcium nitrate aqueous solution, 10 ml of pure water, 0.5 ml of 25% aqueous ammonia, and 3.4 ml (0.215 M) of ammonium dihydrogen phosphate aqueous solution were added to the pure iron powders. Immediately after the addition, the vessel was covered with a lid, and the resultant mixture was agitated with a mix rotor in which the number of rotations was set to 40 rpm. After two hours, the vessel was opened, 1.0 g of ultrahigh purity colloidal silica (“Quartron PL-7” manufactured by FUSO CHEMICAL CO., LTD.; a particle size is 120 nm; and a SiO₂ concentration is 23% by mass) was added dropwise, and the vessel was covered again with a lid. Then the resultant mixture was agitated for 1.0 hour with the mix rotor in which the number of rotations was set to 40 rpm.

An iron powder dispersed solution after the agitation was subjected to suction filtration using No. 5C filter paper for quantitative analysis, and a filtered material was washed with acetone. The iron powders that were obtained were dried in a vacuum desiccator to obtain SiO₂/HAP coated iron powders.

Subsequently, 30 g of SiO₂/HAP coated iron powders was put into a 50 ml volume polypropylene vessel, a mixed solution of 0.23 g of PTES/2.0 g of ethanol was added dropwise, and then the resultant mixture was shaken in the vessel for 10 minutes. Then, the contents in the vessel were discharged into a stainless steel schale, and was subjected to preliminary curing at 200° C. for 30 minutes under atmospheric pressure.

7.0 g of the iron powders that were obtained was filled into a mold having an inner diameter of 14 mm, and was molded into a cylindrical tablet at a molding pressure of 1,000 MPa. As a lubricant, 1 mass % zinc stearate/ethanol solution was used, and this lubricant was applied on a wall surface of the mold. At this time, the thickness of the tablet that was obtained was approximately 5 mm. This tablet was annealed at 600° C. for one hour under a nitrogen atmosphere, a surface of a molded body was polished, and then a specific resistivity was measured (the number n of measurement samples was 5). The specific resistivity of the molded body was 45.6 μΩm, and the density of the molded body was 7.32 g/cm³.

Example 1 and Example 2 were collectively shown in Table 2. The density of the molded body was slightly decreased, but the specific resistivity was clearly improved by changing the particle size of SiO₂ from 40 nm to 120 nm.

TABLE 2

| | Coating | Coating | | Application | Specific resistivity | Specific resistivity | |
|---|---|---|---|---|---|---|---|
| | amount of | amount of | Particle size of | amount of PTES | before baking | after annealing at | Density of molded |
| | HAP (%) | SiO₂ (%) | SiO₂ (nm) | (%) | (μΩm) | 600° C. (μΩm) | body (g/cm³) |
| Example 1 | 0.4 | 0.8 | 40 | 0.75 | 161 | 23.2 | 7.33 |
| Example 2 | | | 120 | | 156 | 45.6 | 7.32 |

Subsequently, SiO₂ in Example 2 was changed to another metal oxide and then coated metal powders of Examples 3 to 8 were produced.

### Example 3

In regard to Example 2, SiO₂ was changed to aluminum oxide (Al₂O₃; alumina sol manufactured by Nissan Chemical Industries, Ltd.; and a concentration of Al₂O₃ was 10% by mass). A amount of change of each material with respect to iron powders and a coating method were the same as Example 2.

### Example 4

In regard to Example 2, SiO₂ was changed to zinc oxide (ZnO; NanoTek Slurry manufactured by CI Kasei Co., Ltd.). The amount of change of each material with respect to iron powders with respect to each material and the coating method were the same as Example 2.

### Example 5

In regard to Example 2, SiO₂ was changed to yttrium oxide (Y₂O₃; NanoTek Slurry manufactured by CI Kasei Co., Ltd.). The amount of change of each material with respect to iron powders and the coating method were the same as Example 2.

### Example 6

In regard to Example 2, SiO₂ was changed to magnesium oxide (MgO; NanoTek Slurry manufactured by CI Kasei Co., Ltd.). The amount of change of each material with respect to iron powders and the coating method were the same as Example 2.

### Example 7

In regard to Example 2, SiO₂ (0.8%) was changed to SiO₂ (0.4%) and MgO (0.4%) and thus two kinds of metal oxides were used in combination. The amount of change of each material with respect to iron powders and the coating method were the same as Example 2.

### Example 8

In regard to Example 2, SiO₂ (0.8%) was changed to MgO (0.4%) and Y₂O₃ (0.4%) and thus two kinds of metal oxides were used in combination. The amount of change of each material with respect to iron powders and the coating method were the same as Example 2.

7.0 g of each of the iron powders that were obtained in Examples 3 to 8 was filled into a mold having an inner diameter of 14 mm, and was molded into a cylindrical tablet at a molding pressure of 1,000 MPa. As a lubricant, 2 mass % zinc stearate/ethanol solution was used, and this lubricant was applied on a wall surface of the mold. These tablets were annealed at 600° C. for one hour under a nitrogen atmosphere, a surface of molded bodies was polished, and then a specific resistivity was measured (the number n of measurement samples was 5). The specific resistivity of molded bodies and the density of the molded bodies are collectively shown in Table 3. All of the molded bodies shown a high specific resistivity, in molded bodies using Y₂O₃ and MgO other than SiO₂, a slightly high specific resistivity was obtained.

TABLE 3

| | | | | | | Specific | |
|---|---|---|---|---|---|---|---|
| | | | Coating | | Specific | resistivity | |
| | Coating | | amount of | Application | resistivity | after | Density of |
| | amount of | | metal oxide | amount of | before baking | annealing at | molded body |
| | HAP (%) | Metal oxide | (%) | PTES (%) | (μΩm) | 600° C. (μΩm) | (g/cm³) |
| Example 2 | 0.4 | SiO₂ | 0.8 | 0.75 | 156 | 45.6 | 7.32 |
| Example 3 | | Al₂O₃ | | | 141 | 19.2 | 7.45 |
| Example 4 | | ZnO₂ | | | 92 | 12.0 | 7.45 |
| Example 5 | | Y₂O₃ | | | 207 | 42.8 | 7.36 |
| Example 6 | | MgO | | | 107 | 51.1 | 7.33 |
| Example 7 | | SiO₂ + MgO | 0.8 (0.4 + 0.4) | 0.75 | 188 | 43.8 | 7.39 |
| Example 8 | | Y₂O₃ + MgO | 0.8 (0.4 + 0.4) | 0.75 | 169 | 47.0 | 7.38 |

Next, only the alkoxysilane in Example 2 was changed, and coated metal powders of Example 9 (methyl triethoxy silane), Example 10 (decyl triethoxy silane), Example 11 (diphenyl diethoxy silane), and Example 12 (tetraethoxy silane) were produced. In addition, coated metal powders in which phenyl triethoxy silane and methyl triethoxy silane were used in combination were produced in Example 13, and coated metal powders in which phenyl triethoxy silane and diphenyl diethoxy silane were used in combination were produced in Example 14. The other processes were the same as Example 2. 7.0 g of each of the iron powders that were obtained were filled into a mold and were molded into a cylindrical tablet similarly to Example 2. As a lubricant, 2 mass % zinc stearate/ethanol solution was used, and this lubricant was applied on a wall surface of the mold. These tablets were annealed at 600° C. for one hour under a nitrogen atmosphere, a surface of molded bodies was polished, and then a specific resistivity was measured (the number n of measurement samples was 5). The specific resistivity of molded bodies and the density of the molded bodies are collectively shown in Table 4.

TABLE 4

| | | | | Application | | Specific | |
|---|---|---|---|---|---|---|---|
| | Coating | Coating | | amount of | Specific | resistivity after | Density of |
| | amount of | amount of | | alkoxysilane | resistivity before | annealing at | molded body |
| | HAP (%) | SiO₂ (%) | Alkoxysilane | (%) | baking (μΩm) | 600° C. (μΩm) | (g/cm³) |
| Example 2 | 0.4 | 0.8 | Phenyl triethoxy | 0.75 | 156 | 45.7 | 7.32 |
| | | | silane | | | | |
| Example 9 | | | Methyl triethoxy | | 101 | 25.9 | 7.33 |
| | | | silane | | | | |

| Example | Decyl triethoxy | | Molding is inferior (cracking occurs) | | |
|---|---|---|---|---|---|
| 10 | silane | | | | |
| Example | Diphenyl diethoxy | | 501 | 58.2 | 7.31 |
| 11 | silane | | | | |
| Example | Tetraethoxy silane | | 176 | 19.8 | 7.34 |
| 12 | | | | | |
| Example | Phenyl triethoxy | 0.8 (0.4 + 0.4) | 111 | 27.1 | 7.35 |
| 13 | silane + methyl | | | | |
| | triethoxy silane | | | | |
| Example | Phenyl triethoxy | 0.8 (0.4 + 0.4) | 332 | 59.2 | 7.39 |
| 14 | silane + diphenyl | | | | |
| | diethoxy silane | | | | |

From Table 4, it could be understood that there is a tendency that a high specific resistivity was obtained due to a phenyl group present in a structure. In addition, in decyl triethoxy silane, it was assumed that an alkyl group in which a carbon number is large was not suitable because cracking occurred on a side surface of the tablet. When comparing densities of molded bodies in Table 4, all of these were 7.3 to 7.4 g/cm³, and a significant difference in a density due to a difference in a substitution group of alkoxysilane did not occur.

### Example 21

300 g of pure iron powder (water atomized powders; KIP-304 AS manufactured by Kawasaki Steel Corporation; hereinafter, referred to as iron powders) was put into a 500 ml cylindrical polypropylene vessel, and 50 ml (0.358 M) of calcium nitrate aqueous solution, 5.0 ml of 25% aqueous ammonia, and 50 ml (0.215 M) of ammonium dihydrogen phosphate aqueous solution were added to the pure iron powders. Immediately after the addition, the vessel was covered with a lid, and the resultant mixture was agitated with a mix rotor in which the number of rotations was set to 40 rpm. After two hours, the vessel was opened, 9.0 g of ultrahigh purity colloidal silica (“Quartron PL-7” manufactured by FUSO CHEMICAL CO., LTD.; a particle size is 125 nm; and an SiO₂ concentration is 23% by mass) and 1.8 g of ultrahigh purity colloidal silica (“Quartron PL-3” manufactured by FUSO CHEMICAL CO., LTD.; a particle size is 70 nm; and an SiO₂ concentration is 20% by mass) were added dropwise, respectively, and the vessel was covered again with a lid. Then the resultant mixture was agitated for 1.0 hour with the mix rotor in which the number of rotations was set to 40 rpm.

An aqueous solution containing iron powders after the agitation was subjected to suction filtration using No. 5C filter paper for quantitative analysis, and a filtered material was washed with water. The iron powders that were obtained were dried in a vacuum desiccator. In this manner, a layer of an inorganic insulating material was formed on the iron powders through calcium phosphate. An increase in weight of iron powders was measured and it was 1.18% by mass.

Subsequently, “TSR194” (silicone modified epoxy varnish including polyalkyl phenyl siloxane and an epoxy modified alkyd resin) manufactured by Momentive Performance Materials Inc. was dissolved in acetone to produce a resin solution in which a concentration of a solid content is 2.0% by mass. The silicone resin solution that was obtained was added to the iron powders in such a manner that a resin solid content becomes 0.2% with respect to the iron powders, and the resultant material was mixed, and then the resultant mixture was heated and dried at 200° C. for 30 minutes. The iron powders that were obtained were classified using a sieve having an aperture of 250 μm to remove large aggregated particles, thereby producing coated metal powders coated with 0.2% by mass of resin.

Next, a molded body was manufactured by using the coated metal powders that were obtained. Zinc stearate was dispersed in alcohol and this dispersed solution was applied onto a surface of a mold. Then, 7.0 g of the coated metal powders was filled into a mold having an inner diameter of 14 mm, and was molded into a cylindrical tablet at a molding pressure of 1,000 MPa. At this time, the thickness of the tablet that was obtained was approximately 5 mm. Cracking or protrusion was not shown at the end portion or on the top surface and bottom surface of the molded body, and moldability was not particularly problematic. This tablet-shaped molded body was annealed at 600° C. for one hour under a nitrogen atmosphere, a surface of a molded body was polished, and then a specific resistivity was measured and the specific resistivity of the molded body was 131 μΩm (the number n of measurement samples was 5). In addition, the dimensions and mass of the molded body that was obtained were measured and the density of the molded body was 7.24 g/cm³.

### Comparative Example 11

In regard to Example 21, the coating of the silicone resin (TSR194) was not performed, and only the inorganic insulating layer was formed on the iron powders. Then, a molded body was manufactured by using coated iron powders that were obtained. The molded body that was obtained was annealed at 600° C. for 1 hour under a nitrogen atmosphere. A specific resistivity after polishing a surface of the molded body and a density of the molded body that was obtained were measured, and these were 5.3 μΩm and 7.38 g/cm³, respectively.

### Comparative Example 12

In regard to Example 21, only the silicone resin (TSR194, 0.2% by mass) was formed on the iron powders. Then, a molded body was manufactured by using coated iron powders that were obtained. The molded body that was obtained was annealed at 600° C. for 1 hour under a nitrogen atmosphere. A specific resistivity after polishing a surface of the molded body and a density of the molded body that was obtained were measured, and these were 18 μΩm and 7.54 g/cm³, respectively.

### Comparative Example 13

In regard to Example 21, the silicone resin was changed from “TSR194” to resol-type modified phenol resin “S890” (manufactured by Kanebo, Ltd.) and a molded body was manufactured. The tablet-shaped molded body that was obtained was annealed at 600° C. for 1 hour under a nitrogen atmosphere. A specific resistivity after polishing a surface of the molded body and a density of the molded body that was obtained were measured, and these were 29 μΩm and 7.25 g/cm³, respectively.

When comparing the specific resistivity and the density of the molded body of Example 21 and Comparative Examples 11 to 13, in Comparative Example 11 (only with the inorganic insulating material without the silicone resin) and Comparative Example 12 (only with silicone resin), the specific resistivity was low, and a sufficient insulation property was not obtained. In Comparative Example 13, a phenol resin was selected as a resin, and approximately the same density of the molded body was obtained, but the heat resistance of the resin was not sufficient, and the high specific resistivity like Example 1 was not obtained. From this, it can be said that the inorganic insulating layer and the silicone resin (organosilicon-treated insulating layer) are requisite for maintaining the high specific resistivity even after the annealing at a high temperature of 600° C.

Next, a silicone resin other than TSR194 was reviewed. This is described in Examples 22 to 25.

### Example 22

The same processes as Example 21 were performed except that the silicone resin in Example 21 was changed from “TSR194” to “YR3286” (manufactured by Dow Corning Toray Co., Ltd., methyl-based silicone adhesive). The tablet-shaped molded body was annealed at 600° C. for 1 hour under a nitrogen atmosphere, and a specific resistivity after polishing a surface of the molded body was measured, and it was 102 μΩm. A density of the molded body was 7.23 g/cm³.

### Example 23

The silicone resin in Example 21 was changed form “TSR194” to “SH805” (manufactured by Momentive Performance Materials Inc., phenyl methyl-based, high-molecular type thermosetting silicone resin) and a molded body was manufactured. The same processes as Example 21 were performed except for the change of the silicone resin. The tablet-shaped molded body was annealed at 600° C. for 1 hour under a nitrogen atmosphere, and a specific resistivity after polishing a surface of the molded body was measured, and it was 88 μΩm. A density of the molded body was 7.28 g/cm³.

### Example 24

The silicone resin in Example 21 was changed form “TSR194” to “YR3370” (manufactured by Dow Corning Toray Co., Ltd., methyl-based silicone resin) and a molded body was manufactured. The same processes as Example 21 were performed except for the change of the silicone resin. This tablet was annealed at 600° C. for 1 hour under a nitrogen atmosphere, and a specific resistivity after polishing a surface of the molded body was measured, and it was 59 μΩm. A density of the molded body was 7.28 g/cm³.

### Example 25

The silicone resin in Example 21 was changed form “TSR194” to “KR311” (manufactured by Shin-Etsu Chemical Co., Ltd., methylphenyl-based straight silicone resin) and a molded body was manufactured. The same processes as Example 21 were performed except for the change of the silicone resin. The tablet-shaped molded body was annealed at 600° C. for 1 hour under a nitrogen atmosphere, and a specific resistivity after polishing a surface of the molded body was measured, and it was 52 μΩm. A density of the molded body was 7.24 g/cm³.

### Example 26

The silicone resin in Example 21 was changed form “TSR194” to “840 RESIN” (manufactured by Dow Corning Toray Co., Ltd., methylphenyl-based silicone resin) and a molded body was manufactured. The same processes as Example 1 were performed except for the change of the silicone resin. The tablet-shaped molded body was annealed at 600° C. for 1 hour under a nitrogen atmosphere, and a specific resistivity after polishing a surface of the molded body was measured, and it was 72 μΩm. A density of the molded body was 7.24 g/cm³.

From the results in Examples 22 to 26, a high specific resistivity was obtained even in any silicone resin.

This is considered to be because an excellent insulation property is exhibited due to a synergistic effect by the uniform inorganic insulating layer that is formed from the binder (calcium phosphate) and the metal oxide and that is formed on the surface of the metal powders, and the silicone resin that is excellent in heat resistance.

Next, the insulating particle was changed from the colloidal silica to another metal oxide. This is described in Example 27 and 28 to be described below.

### Example 27

The ultrahigh purity colloidal silica “PL3” in Example 21 was changed to alumina slurry (NanoTek slurry manufactured by CI Kasei Co., Ltd; a particle size was 31 nm, and a concentration of Al₂O₃ was 20% by mass). The same processes as Example 1 were performed except for the change of the colloidal silica. The tablet-shaped molded body was annealed at 600° C. for 1 hour under a nitrogen atmosphere, and a specific resistivity after polishing a surface of the molded body was measured, and it was 121 μΩm. A density of the molded body was 7.24 g/cm³. Even when the insulating particle was changed, a high specific resistivity was exhibited similarly to Example 21.

### Example 28

The ultrahigh purity colloidal silica in Example 21 was changed to yttria slurry (NanoTek slurry manufactured by CI Kasei Co., Ltd; a particle size was 33 nm, and a concentration of Y₂O₃ was 20% by mass). The same processes as Example 1 were performed except for the change of the colloidal silica. The tablet-shaped molded body was annealed at 600° C. for 1 hour under a nitrogen atmosphere, and a specific resistivity after polishing a surface of the molded body was measured, and it was 119 μΩm. A density of the molded body was 7.22 g/cm³. Even when the insulating particle was changed, a high specific resistivity was exhibited similarly to Example 21.

Next, introduction of a silane coupling agent was reviewed. This is described in Examples 29 to 32 to be described below.

### Example 29

In regard to Example 21, introduction of epoxy silane was reviewed.

That is, 300 g of pure iron powder (water atomized powders; KIP-304 AS manufactured by Kawasaki Steel Corporation) was put into a 500 ml cylindrical polypropylene vessel, and 50 ml (0.358 M) of calcium nitrate aqueous solution, 5.0 ml of 25% aqueous ammonia, and 50 ml (0.215 M) of ammonium dihydrogen phosphate aqueous solution were added to the pure iron powders. Immediately after the addition, the vessel was covered with a lid, and the resultant mixture was agitated with a mix rotor in which the number of rotations was set to 40 rpm. After two hours, the vessel was opened, 9.0 g of ultrahigh purity colloidal silica (“Quartron PL-7” manufactured by FUSO CHEMICAL CO., LTD.; a particle size is 125 nm; and an SiO₂ concentration is 23% by mass) and 1.8 g of ultrahigh purity colloidal silica (“Quartron PL-3” manufactured by FUSO CHEMICAL CO., LTD.; a particle size is 70 nm; and an SiO₂ concentration is 20% by mass) were added dropwise, respectively, and the vessel was covered again with a lid. Then the resultant mixture was agitated for 1.0 hour with the mix rotor in which the number of rotations was set to 40 rpm.

An aqueous solution containing iron powders after the agitation was subjected to suction filtration using No. 5C filter paper for quantitative analysis, and a filtered material was washed with water. The iron powders that were obtained were dried in a vacuum desiccator. An increase in weight of dried iron powders was measured and it was 1.18% by mass.

Subsequently, “TSR194” manufactured by Momentive Performance Materials Inc. was dissolved in acetone to produce a resin solution in which a concentration of a solid content is 2.0% by mass). A silane coupling agent (KBM-403, manufactured by Shin-Etsu Chemical Co., Ltd) having an epoxy group was added to the silicone resin solution in a proportion of 1/10 of the silicone resin (silicone resin:silane coupling agent=10:1). The solution that was obtained was added to the iron powders in such a manner that a resin solid content becomes 0.2% with respect to the iron powders, and the resultant material was mixed with each other, and then the resultant mixture was heated and dried at 200° C. for 30 minutes. The coated metal powders that were obtained were classified using a sieve having an aperture of 250 μm to remove large aggregated powders and to adjust particle size distribution. A tablet-shaped molding body was manufactured using the coated metal powders that were obtained in the same condition as Example 21, and a specific resistivity and a density of the molded body after annealing the molded body at 600° C. were measured. The measurement results are shown in Table 5.

### Example 30

The silane coupling agent having an epoxy group in Example 29 was changed to a silane coupling agent (KBM103, manufactured by Shin-Etsu Chemical Co., Ltd.) having a phenyl group. The same processes as Example 29 were performed except for the change of the silane coupling agent. The coated metal powders that were obtained were classified using a sieve having an aperture of 250 μm to remove large aggregated powders and to adjust particle size distribution. A tablet-shaped molding body was manufactured using the coated metal powders that were obtained in the same condition as Example 21, and a specific resistivity and a density of the molded body after annealing the molded body at 600° C. were measured. The measurement results are shown in Table 5.

### Example 31

The silane coupling agent having an epoxy group in Example 29 was changed to a silane coupling agent (KBM903, manufactured by Shin-Etsu Chemical Co., Ltd.) having an amino group. The same processes as Example 29 were performed except for the change of the silane coupling agent. The coated metal powders that were obtained were classified using a sieve having an aperture of 250 μm to remove large aggregated powders and to adjust particle size distribution. A tablet-shaped molding body was manufactured using the coated metal powders that were obtained in the same condition as Example 21, and a specific resistivity and a density of the molded body after annealing the molded body at 600° C. were measured. The measurement results are shown in Table 5.

### Example 32

The silane coupling agent having an epoxy group in Example 29 was changed to a silane coupling agent (KBM503, manufactured by Shin-Etsu Chemical Co., Ltd.) having a methacryloxy group. The same processes as Example 29 were performed except for the change of the silane coupling agent. The coated metal powders that were obtained were classified using a sieve having an aperture of 250 pm to remove large aggregated powders and to adjust particle size distribution. A tablet-shaped molding body was manufactured using the coated metal powders that were obtained in the same condition as Example 21, and a specific resistivity and a density of the molded body after annealing the molded body at 600° C. were measured. The measurement results are shown in Table 5.

Results of Examples 29 to 32 are collectively shown in Table 5. It was confirmed that the specific resistivity was improved by introducing the silane coupling agent. In a case where a functional group was a phenyl group (Example 30) and an amino group (Example 31), an effect of increasing the specific resistivity to a very high degree was confirmed and the density of the molded body was not decreased greatly.

TABLE 5

| | | Density of | Specific |
|---|---|---|---|
| | Kind of silane | molded body | resistivity |
| | coupling agent | (g/cm³) | (μΩm) |
| Example 29 | KBM-403 | 7.21 | 178 |
| | (epoxy silane) | | |
| Example 30 | KBM-103 | 7.19 | 220 |
| | (phenyl silane) | | |
| Example 31 | KBM-903 | 7.21 | 220 |
| | (amino silane) | | |
| Example 32 | KBM-503 | 7.20 | 146 |
| | (methacryloxy | | |
| | silane) | | |

Next, molding conditions in Examples 21 to 23 were changed and molded bodies (Examples 33 to 35) were manufactured.

### Example 33

Similarly to Example 21, the coated metal powders were produced, and 7.0 g of the coated metal powders that were obtained was filled into a mold having an inner diameter of 14 mm, and was molded at a molding pressure of 1,500 MPa while heating the mold at 150° C. This tablet-shaped molded body was annealed at 600° C., 650° C., and 700° C., respectively, for 30 minutes under a nitrogen atmosphere, and then a specific resistivity and a density of the molded body after polishing a surface of the molded body were measured.

### Example 34

Coated metal powders were manufactured similarly to Example 22, and 7.0 g of the coated metal powders that were obtained was filled into a mold having an inner diameter of 14 mm, and was molded at a molding pressure of 1,500 MPa while heating the mold at 150° C. This tablet-shaped molded body was annealed at 600° C., 650° C., and 700° C., respectively, for 30 minutes under a nitrogen atmosphere, and then a specific resistivity and a density of the molded body after polishing a surface of the molded body were measured.

### Example 35

Similarly to Example 23, the coated metal powders were produced, and 7.0 g of the coated metal powders that were obtained was filled into a mold having an inner diameter of 14 mm, and was molded at a molding pressure of 1,500 MPa while heating the mold at 150° C. This tablet-shaped molded body was annealed at 600° C., 650° C., and 700° C., respectively, for 30 minutes under a nitrogen atmosphere, and then a specific resistivity and a density of the molded bodies after polishing a surface of the molded body were measured.

Results of Examples 33 to 35 are shown in Table 6.

TABLE 6

| | | Density | | | |
|---|---|---|---|---|---|
| | | of molded | Specific resistivity after annealing | | |
| | Silicone | body | (μΩm) | | |
| | resin | (g/cm³) | 600° C. | 650° C. | 700° C. |
| Example | TSR194 | 7.33 | 805 | 416 | 28 |
| 33 | | | | | |
| Example | YR3286 | 7.34 | (Measurement | 379 | 102 |
| 34 | | | limit) | | |
| Example | SH805 | 7.38 | (Measurement | 269 | 78 |
| 35 | | | limit) | | |

From a result of changing the molding condition, it was confirmed that the specific resistivity and the density of the molded body were improved in all of the molded bodies. With a high temperature, plastic deformation easily occurs in the metal powders, and yield strength decreases largely even by slight temperature increase from room temperature. In addition, it may be assumed that the flowability of a resin also increases with respect to the silicone resin. Therefore, it may be assumed that a molded body and an insulating film that are relatively dense were formed with the warm molding and by raising the molding pressure.

1. A coated metal powder comprising a metal powder containing iron as a main component, and an insulating layer consisting of calcium phosphate and a metal oxide formed on a surface of the metal powder,
wherein an organosilicon compound is located on a surface of or inside of the insulating layer.

2. The coated metal powder according to claim 1,
wherein the organosilicon compound is an alkoxysilane or a reaction product thereof.

3. The coated metal powder according to claim 2,
wherein the reaction product is a hydrolysate of the alkoxysilane and/or a hydrolysis condensate of the alkoxysilane.

4. The coated metal powder according to claim 3,
wherein the alkoxysilane has a phenyl group or a benzyl group.

5. The coated metal powder according to claim 1,
wherein the organosilicon compound is a silicone resin.

6. The coated metal powder according to claim 5,
wherein the silicone resin contains at least one compound of (1), (2), and (3) described below,
(1) a polyorganosiloxane containing a bifunctional siloxane unit,
(2) a mixture of a polyorganosiloxane containing at least one of a monofunctional siloxane unit, a trifunctional siloxane unit, and a tetrafunctional siloxane unit, and a polyorganosiloxane including a bifunctional siloxane unit, and
(3) a polyorganosiloxane containing at least one of a monofunctional siloxane unit, a trifunctional siloxane unit and a tetrafunctional siloxane unit, and a bifunctional siloxane unit.

7. The coated metal powder according to claim 6,
wherein the compound of (1), (2), or (3) has an alkyl group and/or a phenyl group as an organo group.

8. The coated metal powder according to claim 5,
wherein the silicone resin is a curable silicone resin.

9. The coated metal powder according to claim 1,
wherein the calcium phosphate contains at least one selected from the group consisting of monobasic calcium phosphate, dibasic calcium phosphate, dibasic calcium phosphate (anhydride), tribasic calcium phosphate, tricalcium phosphate, α-type tricalcium phosphate, β-type tricalcium phosphate, hydroxyapatite, tetracalcium phosphate, calcium pyrophosphate and calcium dihydrogen pyrophosphate.

10. The coated metal powder according to claim 1,
wherein the calcium phosphate is hydroxyapatite.

11. The coated metal powder according to claim 1,
wherein a particle size of the metal oxide is 10 to 350 nm.

12. The coated metal powder according to claim 1,
wherein the metal oxide includes at least one selected from the group consisting of calcium oxide, magnesium oxide, aluminum oxide, zirconium oxide, iron oxide, silicon dioxide, titanium oxide, yttrium oxide, zinc oxide, copper oxide and cerium oxide.

13. The coated metal powder according to claim 1,
wherein the metal oxide is silicon dioxide.

14. A powder magnetic core formed by compressing and annealing the coated metal powder according to claim 1.

15. An electromagnetic apparatus comprising an iron core,
wherein the iron core is formed from the powder magnetic core according to claim 14.

16. A method of producing the coated metal powder according to claim 1, the method comprising:
a step of reacting an aqueous solution containing a calcium ion and a phosphate ion with a metal powder containing iron as a main component in the presence of a metal oxide to form an insulating layer on a surface of the metal powder; and
a step of bringing an organosilicon compound into contact with a coated metal powder on which the insulating layer is formed to locate the organosilicon compound on a surface of or inside of the insulating layer.

17. A method of producing a powder magnetic core, the method comprising:
compressing and annealing the coated metal powder obtainable by the method of producing according to claim 16.
